(19) United States
(12) Patent Application Publication
(10) Pub. No.: US 2017/0278103 A1
(43) Pub. Date: Sep. 28, 2017

(54) ELECTRONIC DEVICE FOR PROVIDING ELECTRONIC PAYMENT FUNCTION AND METHOD FOR OPERATING THE ELECTRONIC DEVICE

(71) Applicant: SAMSUNG ELECTRONICS CO., LTD., Suwon-si (KR)

(72) Inventors: Su-Cheol CHEONG, Seoul (KR); Seong-Min JE, Suwon-si (KR); Sung-Hyuk SHIN, Seongnam-si (KR); Hyun-Soo KIM, Yongin-si (KR); Heung-Sik SHIN, Jeonju-si (KR)

(21) Appl. No.: 15/427,499

(22) Filed: Feb. 8, 2017

(30) Foreign Application Priority Data
Mar. 24, 2016 (KR) 10-2016-0035590

(51) Int. Cl. G06Q 20/38; G06Q 20/32; G06Q 20/40

(52) U.S. Cl. CPC G06Q 20/3821; G06Q 20/4014; G06Q 20/3278

(57) ABSTRACT

An electronic device for providing electronic payment function and a method for operating the electronic device are provided. The method includes executing a payment application for electronic payment, authenticating a user in the executed payment application, and transmitting a payment signal including payment information corresponding to a user input and signature image data corresponding to the user input.

### CROSS-REFERENCE TO RELATED APPLICATION

This application is based on and claims priority under 35 U.S.C. §119 to a Korean patent application filed in the Korean Intellectual Property Office on Mar. 24, 2016 and assigned Serial No. 10-2016-0035590, the disclosure of which is incorporated by reference herein in its entirety.

### TECHNICAL FIELD

The present disclosure relates generally to an electronic device and a method for operating the electronic device, and for example, to an electronic device for providing an electronic payment function, and a method for operating the electronic device.

### BACKGROUND

Along with the development of mobile communication technology, an electronic device is capable of executing various data communication functions as well as a voice call function.

An electronic device such as a mobile device or a user equipment (UE) may provide various services through various applications.

For example, the electronic device may provide multimedia services including music, video, and digital broadcasting, and network-based communication services including call, wireless Internet, short message service (SMS), and multimedia messaging service (MMS)

As electronic devices have evolved from simple communication means to devices equipped with a variety of functions such as communication, distribution, the Internet, and payment, they are widely used across all fields of society, culture, finance, and distribution.

Further, since the electronic devices support electronic payment such as electronic money or mobile payment, users may pay for services and goods purchased online or offline (when a product is purchased and paid for in a shop or a restaurant) using the electronic devices.

If payment is made using a real plastic credit card or by a mobile payment service through a terminal, a user is prompted to sign on a sign pad connected to a point of sales (POS) device. However, a signature is requested irregularly without any definite rule.

For example, shop A requires no signature for low value payments (for example, 1000 KRW), whereas shop B requires a user's signature even for low value payments.

In other words, a user is or is not requested to enter the user's signature according to a value added network (VAN) (VAN in Korea and acquirer in the U.S.) connected to a POS device of a shop that the user visits, or according to a contract made between the VAN and the shop.

This implies that a user's signature is selectively required according to the contents of a contract between a VAN and the merchant of a shop.

On the part of the user, the user should inconveniently input the user's nominal signature, with no clear rule. Moreover, an employee of a shop often signs signatures just formally on behalf of customers, for a fast payment progress.

Because a user's signature for payment is required due to the policy of a payment service or for non-repudiation, the user's signature is processed in a payment system. However, a payment system requiring no signature may be useful to users.

As described above, even though a user authentication has been performed during payment with electronic money or by mobile payment through an electronic device, a user's signature should be signed additionally after payment information is transmitted to a payment terminal. Although the signature is input for payment to identify a user, electronic payment involves user authentication. Therefore, the action of signing a signature has nothing to do with its original purpose and thus becomes unnecessary in electronic payment.

Accordingly, there is a need for providing an electronic payment method that obviates the need for directly signing a signature, although a user signature required for a conventional payment system is provided.

In addition, an electronic payment method is needed, which can obviate the need for signing an unnecessary signature, in consideration of an electronic payment operation.

The above information is presented as background information only to assist with an understanding of the present disclosure.

### SUMMARY

An example aspect of the present disclosure is to address at least the above-mentioned problems and/or disadvantages and to provide at least the advantages described below. Accordingly, an example aspect of the present disclosure is to provide an electronic device and a method for operating the electronic device, which perform payment without receiving a signature directly from a user.

Another example aspect of the present disclosure is to provide an electronic device and a method for operating the electronic device, which offer higher-level security and safety than a signature signing method by various user authentication operations.

In accordance with an example aspect of the present disclosure, a method for operating an electronic device is provided. The method includes executing a payment application for electronic payment, authenticating a user in the executed payment application, and transmitting a payment signal including payment information corresponding to a user input and signature image data corresponding to the user input.

In accordance with another example aspect of the present disclosure, a method for operating an electronic device is provided. The method includes receiving a payment signal including payment information corresponding to a user input and signature image data corresponding to a user, and performing payment using the payment information and the signature image data.

In accordance with another example aspect of the present disclosure, an electronic device is provided. The electronic device includes a memory, a communication module comprising communication circuitry configured to transmit a payment signal, and a processor connected electrically to the memory and the communication module. The memory stores instructions which when executed, cause the processor to execute a payment application for electronic payment, to authenticate a user in the executed payment application, and to transmit a payment signal including payment information corresponding to a user input and signature image data of the user.

In accordance with another example aspect of the present disclosure, an electronic device is provided. The electronic device includes a memory, a communication module comprising communication circuitry configured to transmit a payment signal, and a processor connected electrically to the memory and the communication module. The memory stores instructions which when executed, cause the processor to receive a payment signal including payment information corresponding to an input of an authenticated user and signature image data corresponding to the authenticated user, and to perform payment using the payment information and the signature image data.

Other aspects, advantages, and salient features of the disclosure will become apparent to those skilled in the art from the following detailed description, which, taken in conjunction with the annexed drawings, discloses example embodiments of the disclosure.

### BRIEF DESCRIPTION OF THE DRAWINGS

The above and other aspects, features and advantages of the present disclosure will be more apparent from the following detailed description, taken in conjunction with the accompanying drawings, in which like reference numerals refer to like elements, and wherein:

FIG. 1 is a block diagram illustrating an example electronic device and a network according to various example embodiments of the present disclosure;

FIG. 2 is a block diagram illustrating an example electronic device according to various example embodiments of the present disclosure;

FIG. 3 is a block diagram illustrating an example programming module according to various example embodiments of the present disclosure;

FIG. 4 is a diagram illustrating an example electronic payment operation in an electronic device according to an example embodiment of the present disclosure;

FIG. 5 is a diagram illustrating example transmission of payment information and signature image data in an electronic device according to an example embodiment of the present disclosure;

FIG. 6 is a diagram illustrating an example magnetic secure transmission (MST) data structure according to an example embodiment of the present disclosure;

FIG. 7 is a diagram illustrating an example near field communication (NFC) data structure according to an example embodiment of the present disclosure;

FIG. 8 is a diagram illustrating an example electronic payment system according to an example embodiment of the present disclosure;

FIG. 9 is a sequence diagram illustrating an example signal flow for an example operation for registering payment information according to an example embodiment of the present disclosure;

FIG. 10 is a sequence diagram illustrating an example signal flow for an example payment operation according to an example embodiment of the present disclosure;

FIG. 11 is a sequence diagram illustrating an example signal flow for an example operation for querying about a signature code according to an embodiment of the present disclosure;

FIG. 12 is a sequence diagram illustrating an example signal flow for an example method for operating an electronic payment system according to an example embodiment of the present disclosure;

FIG. 13 is a sequence diagram illustrating an example signal flow for an example operation for querying about a signature add code according to an example embodiment of the present disclosure;

FIG. 14 is a sequence diagram illustrating an example signal flow for an example method for operating an electronic payment system according to an example embodiment of the present disclosure;

FIG. 15 is a sequence diagram illustrating an example signal flow for an example method for operating an electronic payment system according to an example embodiment of the present disclosure;

FIG. 16 is a sequence diagram illustrating an example signal flow for an example operation for setting signature-free payment according to an example embodiment of the present disclosure;

FIG. 17 is a sequence diagram illustrating an example signal flow for an example payment operation according to an example embodiment of the present disclosure;

FIG. 18 is a diagram illustrating databases (DBs) related to signature-free payment according to an example embodiment of the present disclosure; and

FIG. 19 is a sequence diagram illustrating an example signal flow for an example payment operation according to an example embodiment of the present disclosure.

### DETAILED DESCRIPTION

Various example embodiments of the present disclosure are described with reference to the accompanying drawings. However, the scope of the present disclosure is not intended to be limited to the particular embodiments and it is to be understood that the present disclosure covers all modifications, equivalents, and/or alternatives falling within the scope and spirit of the present disclosure. In relation to a description of the drawings, like reference numerals denote the same components.

In the present disclosure, the term ‘have’, ‘may have’, ‘include’, or ‘may include’ signifies the presence of a specific feature (for example, number, function, operation, or component such as part), not excluding the presence of one or more other features.

In the present disclosure, the term ‘A or B’, ‘at least one of A or/and B’, or ‘one or more of A or/and B’ may cover all possible combinations of enumerated items. For example, ‘A or B’, ‘at least one of A and B’, or ‘at least one of A or B’ may represent all of the cases of (1) inclusion of at least one A, (2) inclusion of at least one B, and (3) inclusion of at least one A and at least one B.

The term as used in the present disclosure, ‘first’ or ‘second’ may modify the names of various components irrespective of sequence and/or importance, not limiting the components. These expressions are used to distinguish one component from another component. For example, a first user equipment (UE) and a second UE may indicate different UEs irrespective of sequence or importance. For example, a first component may be referred to as a second component and vice versa without departing the scope of the present disclosure.

When it is said that a component (for example, a first component) is ‘operatively or communicatively coupled with/to’ or ‘connected to’ another component (for example, a second component), it should be understood that the one component is connected to the other component directly or through any other component (for example, a third component). On the other hand, when it is said that a component (for example, a first component) is ‘directly connected to’ or ‘directly coupled to’ another component (for example, a second component), it may be understood that there is no other component (for example, a third component) between the components.

The term ‘configured to’ as used herein may be replaced with, for example, the term ‘suitable for’ ‘having the capacity to’, ‘designed to’, ‘adapted to’, ‘made to’, or ‘capable of’ under circumstances. The term ‘configured to’ may not necessarily refer to ‘specifically designed to’ in hardware. Instead, the term ‘configured to’ may refer to a situation in which a device may be ‘capable of’ with another device or part. For example, ‘a processor configured to execute A, B, and C’ may refer, for example, to a dedicated processor (for example, an embedded processor) for performing the corresponding operations or a generic-purpose processor (for example, a central processing unit (CPU) or an application processor (AP)) for performing the operations.

The terms as used in the present disclosure are provided to describe various example embodiments, not intended to limit the scope of other embodiments. It is to be understood that singular forms include plural referents unless the context clearly dictates otherwise. Unless otherwise defined, the terms and words including technical or scientific terms used in the following description and claims may have the same meanings as generally understood by those skilled in the art. The terms as generally defined in dictionaries may be interpreted as having the same or similar meanings as or to contextual meanings of related technology. Unless otherwise defined, the terms should not be interpreted as ideally or excessively formal meanings. When needed, even the terms defined in the present disclosure should not be interpreted as excluding embodiments of the present disclosure.

An electronic device according to various embodiments of the present disclosure may be at least one of, for example, a smartphone, a tablet personal computer (PC), a mobile phone, a video phone, an e-book reader, a desktop PC, a laptop PC, a netbook computer, a workstation, a server, a personal digital assistant (PDA), a portable multimedia player (PMP), an MP3 player, a mobile medical equipment, a camera, or a wearable device. According to various embodiments, the wearable device may be at least one of an accessory type (for example, a watch, a ring, a bracelet, an ankle bracelet, a necklace, glasses, contact lenses, or a head-mounted device (HMD)), a fabric or clothes type (for example, electronic clothes), a body-attached type (for example, a skin pad or a tattoo), or an implantable type (for example, an implantable circuit), or the like, but is not limited thereto.

According to some embodiments, an electronic device may be a home appliance. For example, the home appliance may be at least one of, for example, a television (TV), a digital versatile disk (DVD) player, an audio player, a refrigerator, an air conditioner, a vacuum cleaner, an oven, a microwave oven, a washer, an air purifier, a set-top box, a home automation control panel, a security control panel, a TV box (for example, Samsung HomeSync™, Apple TV™, Google TV™, or the like), a game console (for example, Xbox™, PlayStation™, or the like), an electronic dictionary, an electronic key, a camcorder, or an electronic picture frame, or the like, but is not limited thereto.

According to other embodiments, an electronic device may be at least one of a medical device (for example, a portable medical meter such as a blood glucose meter, a heart rate meter, a blood pressure meter, or a body temperature meter, a magnetic resonance angiography (MRA) device, a magnetic resonance imaging (MRI) device, a computed tomography (CT) device, an imaging device, an ultrasonic device, or the like), a navigation device, a global navigation satellite system (GNSS), an event data recorder (EDR), a flight data recorder (FDR), an automotive infotainment device, a naval electronic device (for example, a naval navigation device, a gyrocompass, or the like), an avionic electronic device, a security device, an in-vehicle head unit, an industrial or consumer robot, an automatic teller machine (ATM) in a financial facility, a point of sales (POS) device in a shop, or an Internet of things (IoT) device (for example, a lighting bulb, various sensors, an electricity or gas meter, a sprinkler, a fire alarm, a thermostat, a street lamp, a toaster, sports goods, a hot water tank, a heater, or a boiler), or the like, but is not limited thereto.

According to some embodiments, an electronic device may be at least one of furniture, part of a building/structure, an electronic board, an electronic signature receiving device, a projector, and various measuring devices (for example, water, electricity, gas or electro-magnetic wave measuring devices), or the like, but is not limited thereto. According to various embodiments, an electronic device may be one or a combination of two or more of the foregoing devices. According to some embodiments, an electronic device may be a flexible electronic device. In addition, it will be apparent to one having ordinary skill in the art that an electronic device according to an embodiment of the present disclosure is not limited to the foregoing devices and covers a new electronic device produced along with technology development.

With reference to the attached drawings, an electronic device according to various example embodiments will be described below. In the present disclosure, the term ‘user’ may refer to a person or device (for example, artificial intelligence electronic device) that uses an electronic device.

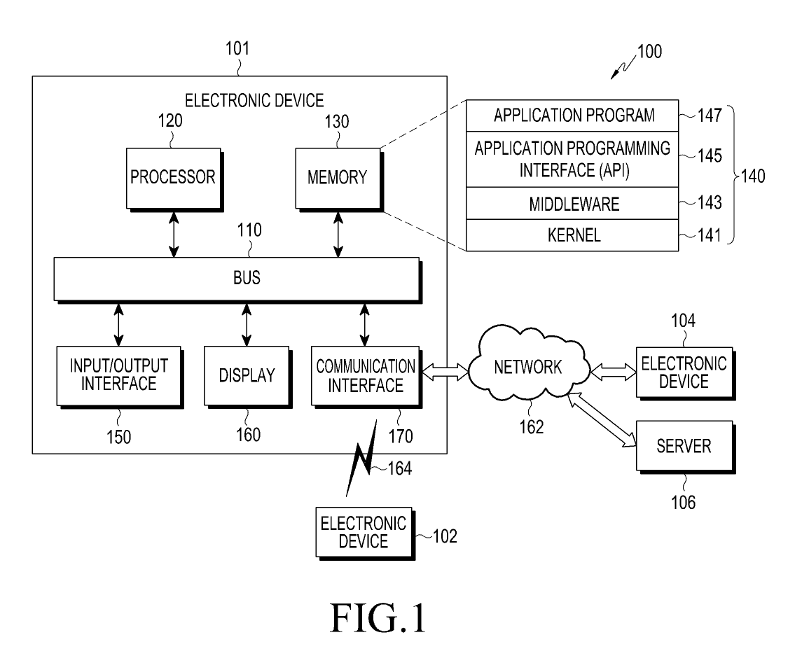

Referring to FIG. 1, an electronic device 101 in a network environment 100 according to various example embodiments is described. The electronic device 101 may include a bus 110, a processor (e.g., including processing circuitry) 120, a memory 130, an input/output (I/O) interface (e.g., including input/output circuitry) 150, a display 160, and a communication interface (e.g., including communication circuitry) 170. In some embodiments, at least one of the components may be omitted in the electronic device 101 or a component may be added to the electronic device 101.

The bus 110 may include a circuit that interconnects, for example, the foregoing components 120, 130, 150, 160, and 170 and allows communication (for example, control messages and/or data) between the foregoing components.

The processor 120 may include various processing circuitry, such as, for example, and without limitation, one or more of a dedicated processor, a CPU, an AP, or a communication processor (CP). The processor 120 may, for example, execute computation or data processing related to control and/or communication of at least one other component of the electronic device 101.

The memory 130 may include a volatile memory and/or a non-volatile memory. The memory 130 may, for example, store instructions or data related to at least one other component. According to an embodiment, the memory 130 may store software and/or programs 140. The programs 140 may include, for example, a kernel 141, middleware 143, an application programming interface (API) 145, and/or application programs (or applications) 147. At least a part of the kernel 141, the middleware 143, and the API 145 may be called an operating system (OS).

The kernel 141 may control or manage system resources (for example, the bus 110, the processor 120, or the memory 130) that are used in executing operations or functions implemented in other programs such as the middleware 143, the API 145, or the application programs 147. Also, the kernel 141 may provide an interface for allowing the middleware 143, the API 145, or the application programs 147 to access individual components of the electronic device 101 and control or manage system resources.

The middleware 143 may serve as a medium through which the kernel 141 may communicate with, for example, the API 145 or the application programs 147 to transmit and receive data.

Also, the middleware 143 may process one or more task requests received from the application programs 147 according to their priority levels. For example, the middleware 143 may assign priority levels for using system resources (the bus 110, the processor 120, or the memory 130) of the electronic device 101 to at least one of the application programs 147. For example, the middleware 143 may perform scheduling or load balancing for the one or more task requests by processing the one or more task requests according to the priority levels assigned to the at least one application program 147.

The API 145 is an interface that may control functions that the application programs 147 provide at the kernel 141 or the middleware 143. For example, the API 145 may include at least one interface or function (for example, a command) for file control, window control, video processing, or text control.

The I/O interface 150 may include various input/output circuitry and, for example, act as an interface that provides a command or data received from a user or an external device to the other component(s) of the electronic device 101. Further, the I/O interface 150 may output a command or data received from the other component(s) of the electronic device 101 to the user or the external device.

The display 160 may include, for example, a liquid crystal display (LCD), a light emitting diode (LED) display, an organic LED (OLED) display, a microelectromechanical systems (MEMS) display, or an electronic paper display, or the like, but is not limited thereto. The display 160 may display, for example, various types of content (for example, text, an image, a video, an icon, or a symbol) to the user. The display 160 may include a touch screen and receive, for example, a touch input, a gesture input, a proximity input, or a hovering input through an electronic pen or a user's body part.

The communication interface 170 may include various communication circuitry configured to establish communication, for example, between the electronic device 101 and an external device (for example, a first external electronic device 102, a second external electronic device 104, or a server 106). For example, the communication interface 170 may be connected to a network 162 by wireless communication or wired communication and communicate with the external device (for example, the second external electronic device 104 or the server 106) over the network 162.

The wireless communication may be conducted using, for example, at least one of long term evolution (LTE), LTE-advanced (LTE-A), code division multiple access (CDMA), wideband CDMA (WCDMA), universal mobile telecommunication system (UNITS), wireless broadband (WiBro), or global system for mobile communications (GSM), as a cellular communication protocol. The wireless communication may include, for example, short-range communication 164. The short-range communication 164 may be conducted by, for example, at least one of wireless fidelity (WiFi), Bluetooth, near field communication (NFC), or GNSS. GNSS may include, for example, at least one of global positioning system (GPS), global navigation satellite system (Glonass), Beidou navigation satellite system (hereinafter, referred to as ‘Beidou’), or Galileo, the European global satellite-based navigation system, according to a region using the GNSS or a used bandwidth. In the present disclosure, the terms ‘GPS’ and ‘GNSS’ are interchangeably used with each other. The wired communication may be conducted in conformance to, for example, at least one of universal serial bus (USB), high definition multimedia interface (HDMI), recommended standard 232 (RS-232), or plain old telephone service (POTS). The network 162 may be a communication network, for example, at least one of a computer network (for example, local area network (LAN) or wide area network (WAN)), the Internet, or a telephone network.

Each of the first and second external electronic devices 102 and 104 may be of the same type as or a different type from the electronic device 101. According to an embodiment, the server 106 may include a group of one or more servers. According to various embodiments, all or a part of operations performed in the electronic device 101 may be performed in one or more other electronic devices (for example, the electronic devices 102 and 104) or the server 106. According to an embodiment, if the electronic device 101 is to perform a function or a service automatically or upon request, the electronic device 101 may request at least a part of functions related to the function or the service to another device (for example, the electronic device 102 or 104 or the server 106), instead of performing the function or the service autonomously, or additionally. The other electronic device (for example, the electronic device 102 or 104 or the server 106) may execute the requested function or an additional function and provide a result of the function execution to the electronic device 101. The electronic device 101 may provide the requested function or service based on the received result or by additionally processing the received result. For this purpose, for example, cloud computing, distributed computing, or client-server computing may be used.

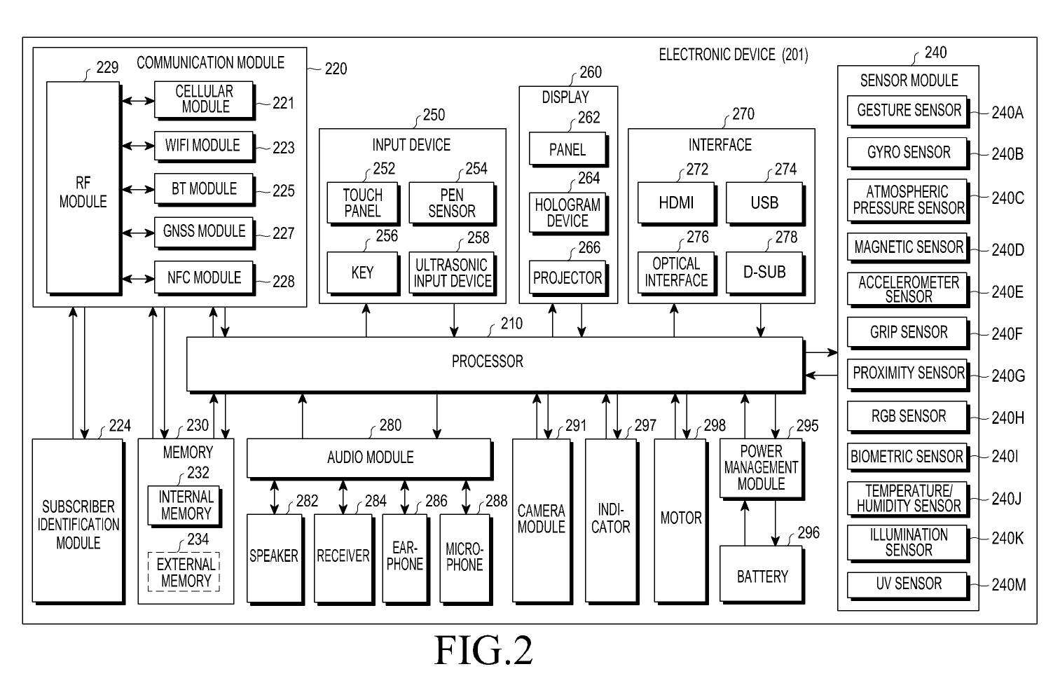

FIG. 2 is a block diagram illustrating an example electronic device 201 according to an example embodiment. The electronic device 201 may include, for example, the whole or part of the electronic device 101 illustrated in FIG. 1. The electronic device 201 may include at least one processor (for example, AP) (e.g., including processing circuitry) 210, a communication module (e.g., including communication circuitry) 220, a subscriber identification module (SIM) 224, a memory 230, a sensor module 240, an input device (e.g., including input circuitry) 250, a display 260, an interface (e.g., including interface circuitry) 270, an audio module 280, a camera module 291, a power management module 295, a battery 296, an indicator 297, and a motor 298.

The processor 210 may include various processing circuitry and may, for example, control a plurality of hardware or software components that are connected to the processor 210 by executing an OS or an application program and may perform processing or computation of various types of data. The processor 210 may be implemented, for example, as a system on chip (SoC). According to an embodiment, the processor 210 may further include a graphics processing unit (GPU) and/or an image signal processor. The processor 210 may include at least a part (for example, a cellular module 221) of the components illustrated in FIG. 2. The processor 210 may load a command or data received from at least one of other components (for example, a non-volatile memory), process the loaded command or data, and store various types of data in the non-volatile memory.

The communication module 220 may have the same configuration as or a similar configuration to the communication interface 170 illustrated in FIG. 1. The communication module 220 may include various communication circuitry, such as, for example, and without limitation, the cellular module 221, a WiFi module 223, a Bluetooth (BT) module 225, a GNSS module 227 (for example, a GPS module, a Glonass module, a Beidou module, or a Galileo module), an NFC module 228, and a radio frequency (RF) module 229.

The cellular module 221 may provide services such as voice call, video call, text service, or the Internet service, for example, through a communication network. According to an embodiment, the cellular module 221 may identify and authenticate the electronic device 201 within a communication network, using the SIM (for example, a SIM card) 224. According to an embodiment, the cellular module 221 may perform at least a part of the functionalities of the processor 210. According to an embodiment, the cellular module 221 may include a CP.

Each of the WiFi module 223, the BT module 225, the GNSS module 227, and the NFC module 228 may include, for example, a processor that may process data received or transmitted by the module. According to an embodiment, at least a part (for example, two or more) of the cellular module 221, the WiFi module 223, the BT module 225, the GNSS module 227, or the NFC module 228 may be included in a single integrated chip (IC) or IC package.

The RF module 229 may transmit and receive, for example, communication signals (for example, RF signals). The RF module 229 may include at least one of, for example, a transceiver, a power amplifier module (PAM), a frequency filter, a low noise amplifier (LNA), an antenna, or the like. According to another embodiment, at least one of the cellular module 221, the WiFi module 223, the BT module 225, the GNSS module 227, or the NFC module 228 may transmit and receive RF signals via a separate RF module.

The SIM 224 may include, for example, a card including the SIM and/or an embedded SIM. The SIM 224 may include a unique identifier (for example, integrated circuit card identifier (ICCID)) or subscriber information (for example, international mobile subscriber identity (IMSI)).

The memory 230 (for example, the memory 130) may include, for example, an internal memory 232 and/or an external memory 234. The internal memory 232 may be at least one of, for example, a volatile memory (for example, dynamic RAM (DRAM), static RAM (SRAM), or synchronous dynamic RAM (SDRAM)), and a non-volatile memory (for example, one time programmable ROM (OTPROM), programmable ROM (PROM), erasable and programmable ROM (EPROM), electrically erasable and programmable ROM (EEPROM), mask ROM, flash ROM, flash memory (for example, NAND flash memory, or NOR flash memory), a hard drive, and a solid state driver (SSD).

The external memory 234 may further include a flash drive such as a compact flash (CF) drive, a secure digital (SD), a micro secure digital (micro-SD), a mini secure digital (mini-SD), an extreme digital (xD), a multi-media card (MMC), or a memory stick. The external memory 234 may be operatively and/or physically coupled to the electronic device 201 via various interfaces.

The sensor module 240 may, for example, measure physical quantities or detect operational states of the electronic device 201, and convert the measured or detected information into electric signals. The sensor module 240 may include at least one of, for example, a gesture sensor 240A, a gyro sensor 240B, an atmospheric pressure sensor 240C, a magnetic sensor 240D, an accelerometer sensor 240E, a grip sensor 240F, a proximity sensor 240G, a color sensor (for example, a red, green, blue (RGB) sensor) 240H, a biometric sensor 240I, a temperature/humidity sensor 240J, an illumination sensor 240K, or an ultra violet (UV) sensor 240M. Additionally or alternatively, the sensor module 240 may include, for example, an electrical-nose (E-nose) sensor, an electromyogram (EMG) sensor, an electroencephaloeram (EEG) sensor, an electrocardiogram (ECG) sensor, an infrared (IR) sensor, an iris sensor, and/or a finger print sensor. The sensor module 240 may further include a control circuit for controlling one or more sensors included therein. According to some embodiments, the electronic device 201 may further include a processor configured to control the sensor module 240, as a part of or separately from the processor 210. Thus, while the processor 210 is in a sleep state, the control circuit may control the sensor module 240.

The input device 250 may include various input circuitry, such as, for example, and without limitation, a touch panel 252, a (digital) pen sensor 254, a key 256, or an ultrasonic input device 258. The touch panel 252 may operate in at least one of, for example, capacitive, resistive, infrared, and ultrasonic schemes. The touch panel 252 may further include a control circuit. The touch panel 252 may further include a tactile layer to thereby provide haptic feedback to the user.

The (digital) pen sensor 254 may include, for example, a detection sheet which is a part of the touch panel or separately configured from the touch panel. The key 256 may include, for example, a physical button, an optical key, or a keypad. The ultrasonic input device 258 may sense ultrasonic signals generated by an input tool using a microphone (for example, a microphone 288), and identify data corresponding to the sensed ultrasonic signals.

The display 260 (for example, the display 160) may include a panel 262, a hologram device 264, or a projector 266. The panel 262 may have the same configuration as or a similar configuration to the display 160 illustrated in FIG. 1. The panel 262 may be configured to be, for example, flexible, transparent, or wearable. The panel 262 and the touch panel 252 may be implemented as a single module. The hologram device 264 may utilize the interference of light waves to provide a three-dimensional image in empty space. The projector 266 may display an image by projecting light on a screen. The screen may be positioned, for example, inside or outside the electronic device 201. According to an embodiment, the display 260 may further include a control circuit for controlling the panel 262, the hologram device 264, or the projector 266. Meanwhile, as described before, the display 260 may include a plurality of displays, which will be described later.

The interface 270 may include various interface circuitry, such as, for example, and without limitation, an HDMI 272, a USB 274, an optical interface 276, or a D-subminiature (D-sub) 278. The interface 270 may be included, for example, in the communication interface 170 illustrated in FIG. 1. Additionally or alternatively, the interface 270 may include, for example, a mobile high-definition link (MHL) interface, an SD/multimedia card (MMC) interface, or an infrared data association (IrDA) interface.

The audio module 280 may, for example, convert a sound to an electrical signal, and vice versa. At least a part of the components of the audio module 280 may be included, for example, in the I/O interface 150 illustrated in FIG. 1. The audio module 280 may process sound information input into, or output from, for example, a speaker 282, a receiver 284, an earphone 286, or the microphone 288.

The camera module 291 may capture, for example, still images and a video. According to an embodiment, the camera module 291 may include one or more image sensors (for example, a front sensor or a rear sensor), a lens, an image signal processor (ISP), or a flash (for example, an LED or a xenon lamp).

The power management module 295 may manage power of, for example, the electronic device 201. According to an embodiment, the power management module 295 may include a power management integrated circuit (PMIC), a charger IC, or a battery or fuel gauge. The PMIC may adopt wired and/or wireless charging. The wireless charging may be performed, for example, in a magnetic resonance scheme, a magnetic induction scheme, or an electromagnetic wave scheme, and may further include an additional circuit for wireless charging, for example, a coil loop, a resonance circuit, or a rectifier. The battery gauge may measure, for example, a charge level, a voltage while charging, current, or temperature of the battery 296. The battery 296 may include, for example, a rechargeable battery and/or a solar battery.

The indicator 297 may indicate specific states of the electronic device 201 or a part of the electronic device 201 (for example, the processor 210), for example, boot status, message status, or charge status. The motor 298 may convert an electrical signal into a mechanical vibration and generate vibrations or a haptic effect. While not shown, the electronic device 201 may include a processing device for supporting mobile TV (for example, a GPU). The processing device for supporting mobile TV may process media data compliant with, for example, digital multimedia broadcasting (DMB), digital video broadcasting (DVB), or MediaFLO™.

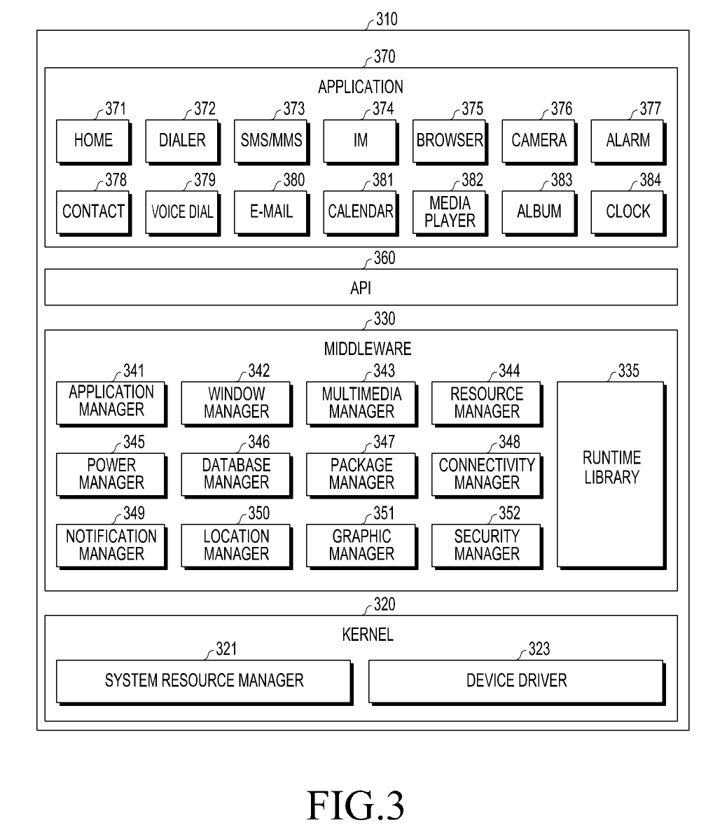

FIG. 3 is a block diagram illustrating an example programming module according to various example embodiments of the present disclosure. According to an embodiment, a programming module 310 (for example, a program 140) may include an OS that controls resources related to an electronic device (for example, the electronic device 101) and/or various applications executed on the OS (for example, the application programs 147). For example, the OS may be Android, iOS, Windows, Symbian, Tizen, Bada, or the like.

The programming module 310 may include a kernel 320, middleware 330, an Application Programming Interface (API) 360, and/or applications 370. At least a part of the programming module 310 may be preloaded on the electronic device or downloaded from an external electronic device (for example, the electronic device 102 or 104, or the server 106).

The kernel 320 (for example, the kernel 141) may include, for example, a system resource manager 321 and/or a device driver 323. The system resource manager 321 may control, allocate, or deallocate system resources. According to an embodiment, the system resource manager 321 may include at least one of a process manager, a memory manager, or a file system manager. The device driver 323 may include, for example, a display driver, a camera driver, a Bluetooth driver, a shared memory driver, a USB driver, a keypad driver, a WiFi driver, an audio driver, or an inter-process communication (IPC) driver.

The middleware 330 may, for example, provide a function required commonly for the applications 370 or provide various functionalities to the applications 370 through the API 360 so that the applications 370 may efficiently use limited system resources available within the electronic device. According to an embodiment, the middleware 330 (for example, the middleware 143) may include at least one of a runtime library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, or a security manager 352.

The runtime library 335 may include, for example, a library module that a complier uses to add a new function in a programming language during execution of an application 370. The runtime library 335 may perform input/output management, memory management, a function related to arithmetic function, or the like.

The application manager 341 may manage, for example, the life cycle of at least one of the applications 370. The window manager 342 may manage GUI resources used for a screen. The multimedia manager 343 may determine formats required to play back various media files and may encode or decode a media file using a CODEC suitable for the format of the media file. The resource manager 344 may manage resources such as a source code of at least one of the applications 370, a memory, or storage space.

The power manager 345 may, for example, manage a battery or a power source by operating in conjunction with a basic input/output system (BIOS) and may provide power information required for an operation of the electronic device. The database manager 346 may generate, search, or modify a database for at least one of the applications 370. The package manager 347 may manage installation or update of an application distributed as a package file.

The connectivity manager 348 may manage, for example, wireless connectivity of WiFi, Bluetooth, or the like. The notification manager 349 may indicate or notify an event such as message arrival, a schedule, a proximity alarm, or the like in a manner that does not bother a user. The location manager 350 may mange position information about the electronic device. The graphic manager 351 may manage graphical effects to be provided to the user or related user interfaces. The security manager 352 may provide an overall security function required for system security, user authentication, or the like. In an embodiment, if the electronic device (for example, the electronic device 101) has a telephony function, the middleware 330 may further include a telephony manager to manage a voice or video call function of the electronic device.

A new middleware module may be created and used by combining various functions of the above-described component modules in the middleware 330. The middleware 330 may provide a customized module for each OS type in order to provide differentiated functions. In addition, the middleware 330 may dynamically delete a part of the existing components or add a new component.

The API 360 (for example, the API 145) is, for example, a set of API programming functions, which may be configured differently according to an OS. For example, in the case of Android or iOS, one API set may be provided per platform, whereas in the case of Tizen, two or more API sets may be provided per platform.

The applications 370 (for example, the application programs 147) may include, for example, one or more applications capable of providing functions such as home 371, dialer 372, short message service/multimedia messaging service (SMS/MMS) 373, Instant message (IM) 374, browser 375, camera 376, alarm 377, contact 378, voice dial 379, email 380, calendar 381, media player 382, album 383, or clock 384, health care (for example, measurement of an exercise amount or a glucose level), or providing of environment information (for example, information about atmospheric pressure, humidity, or temperature).

According to an embodiment, the applications 370 may include an application (for the convenience of description, referred to as ‘information exchange application’) supporting information exchange between the electronic device (for example, the electronic device 101) and an external electronic device (the electronic device 102 or 104). The information exchange application may include, for example, a notification relay application for transmitting specific information to the external electronic device or a device management application for managing the external electronic device.

For example, the notification relay application may include a function of transmitting notification information generated from another application (for example, an SMS/MMS application, an email application, a health care application, or an environment information application) to the external electronic device (for example, the electronic device 102 or 104). Also, the notification relay application may, for example, receive notification information from the external electronic device and transmit the received notification information to a user.

The device management application may, for example, manage (for example, install, delete, or update) at least a part of functions of the external electronic device (for example, the electronic device 102 or 104) communicating with the electronic device (for example, turn-on/turn-off of the external electronic device (or a part of its components) or control of the brightness (or resolution) of the display), an application executed in the external electronic device, or a service (for example, a call service or a message service) provided by the external electronic device.

According to an embodiment, the applications 370 may include an application (for example, a health care application of a mobile medical equipment) designated according to a property of the external electronic device (for example, the electronic device 102 or 104). According to an embodiment, the applications 370 may include an application received from an external electronic device (for example, the server 106 or the electronic device 102 or 104). According to an embodiment, the applications 370 may include a preloaded application or a third party application downloadable from a server. The names of components of the programming module 310 according to the embodiment of the present disclosure may vary according to the type of an OS.

According to an embodiment, at least a part of the programming module 310 may be implemented in software, firmware, hardware, or a combination of at least two of them. At least a part of the programming module 310 may be implemented (for example, executed) by the processor (for example, the processor 210). At least a part of the programming module 310 may include, for example, a module, a program, a routine, a set of instructions, or a process to execute one or more functions.

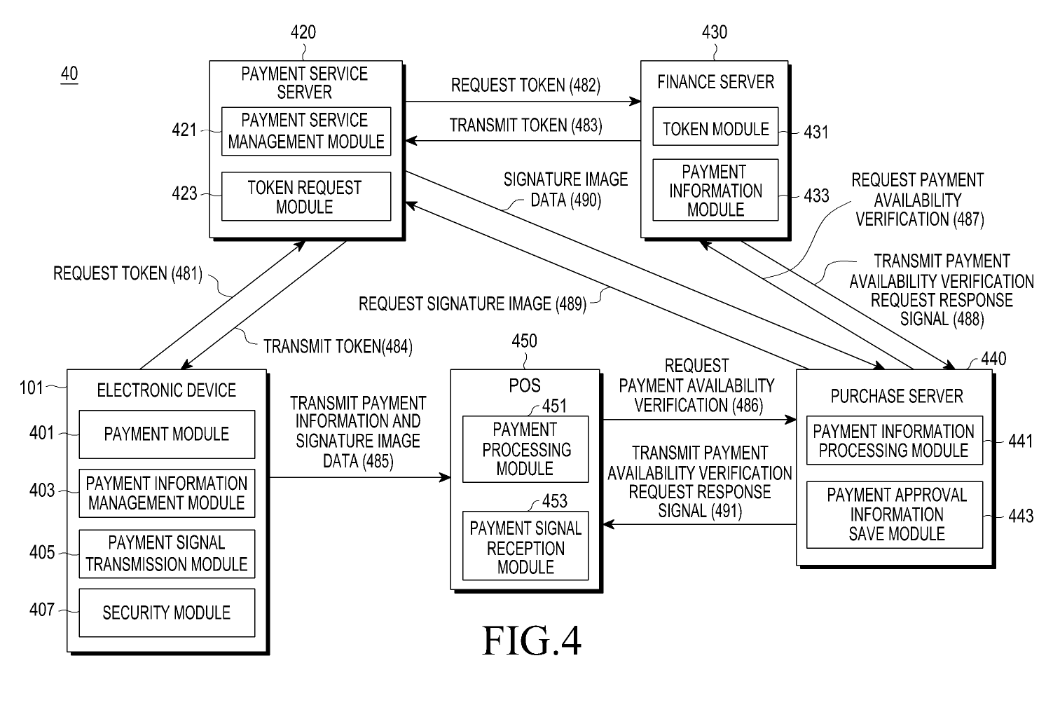

FIG. 4 is a diagram illustrating an example electronic payment operation in an electronic device according to an example embodiment of the present disclosure.

Referring to FIG. 4, an electronic payment system 40 may include the electronic device 101, a payment service server 420, a finance server 430, a purchase server 440, and a POS device 450.

To execute an electronic payment function, the electronic device 101 may transmit payment information to the POS device 450.

The electronic device 101 may include a payment module 401, a payment information management module 403, a payment signal transmission module 405, and a security module 407.

The payment module 401 may request payment information required to execute the electronic payment function, and generate a payment signal using the payment information received in response to the request.

The payment information management module 403 may manage various types of payment information to execute the electronic payment function. For example, the payment information management module 403 may manage card information for payment, card account information, and payment setting information related to payment.

The payment signal transmission module 405 may transmit the payment signal to the POS device 450. The payment signal transmission module 405 may transmit the payment signal in various manners. For example, the payment signal transmission module 405 may transmit the payment signal using at least one of a magnetic secure transmission (MST) module, an NFC module, and so one.

According to an embodiment, the MST module may generate pulses according to transmission data, using an electromagnetic signal, and the pulses may generate a magnetic field signal. The electronic device 101 may transmit the magnetic field signal to the POS device 450, and the POS device 450 may search the magnetic field signal using an MST reader and recover the data by converting the searched magnetic field signal to an electrical signal.

Meanwhile, the payment signal transmission module 405 may be incorporated in the previously described communication interface 170 or communication module 220.

The security module 407 may store various types of information related to payment. According to an embodiment, the security module 407 may include a storage space of a higher security level than the memory 230. For example, a trusted execution environment (TEE) and a storage space (the memory 230 or an embedded security element (eSE)) may be isolated from each other in hardware and/or software, thus providing a safe execution environment and storage space. The safe storage space may be understood in concept as a domain or a container.

Accordingly, the security module 407 may store various types of payment-related information, for example, card information, card user information, and signature image data in the high security-level storage space, and if a user is authenticated, may provide the stored various types of payment-related information.

The payment service server 420 may manage electronic payment or mobile payment, and process various types of payment-related information received from the electronic device 101. For example, the payment service server 420 may be a Samsung Pay server operating to provide a payment service of Samsung Pay.

The payment service server 420 may include a payment service management module 421 and a token request module 423.

The payment service management module 421 may manage various types of payment service information related to electronic payment or mobile payment, and operations for a payment service.

The token request module 423 may request a token to another server, for example, the finance server 430 and transmit the received token to the electronic device 101, in response to a token request received from the electronic device 101. According to an embodiment, a token may refer to information related to electronic payment or mobile payment, and may be understood as information that substitutes for information (for example, a card number) about a payment means (for example, a credit card).

The finance server 430 may transmit the token to the payment service server 420 in response to the token request, and determine whether payment is available in response to a payment availability verification request. The finance server 430 may include a token module 431 and a payment information module 433.

The token module 431 may obtain the token in response to the token request, receive the token from an external server such as a token service provider (TSP), and transmit the obtained token.

The payment information module 433 may store various types of payment-related information. Further, the payment information module 433 may determine whether payment is available and transmit a response according to a determination result, in response to the payment availability verification request.

Meanwhile, the finance server 430 may be implemented in various forms according to the payment environment of each country. For example, while it has been described above that a token is obtained from the finance server 430, an external server (for example, a TSP) connected to the finance server 430 may generate and manage a token, and the finance server 430 may obtain the token from the external server. In addition, the finance server 430 may be a server of a payment network (for example, VisaNet) or a server of a credit card issuer.

The purchase server 440 may store payment approval information. For example, the purchase server 440 may store slip information in response to electronic payment approval.

The purchase server 440 may request the finance server 430 to verify whether payment is available, according to the payment availability verification request received from the POS device 450, and transmit a payment availability verification request response signal. The purchase server 440 may also provide a signature image according to a later-described signature image request.

The purchase server 440 may include a payment information processing module 441 and a payment approval information save module 443.

The payment information processing module 441 may request payment availability verification, and transmit a payment availability verification request response signal. Further, the payment information processing module 441 may provide a signature image in response to a signature image request.

The payment approval information save module 443 may store the payment approval information received from the POS device 450. The payment approval information save module 443 may also provide the payment approval information to the finance server 430.

The POS device 450 may perform payment for a service or goods based on a received payment signal. According to an embodiment, the POS device 450 may be an electronic device 101 capable of making payment. For example, the POS device 450 may be a cradle-type electronic device or a portable electronic device (for example, mPOS). In addition, the POS device 450 may be an electronic device combined with a module capable of performing payment. For example, the POS device 450 may be a smartphone or tablet equipped with a POS solution.

The POS device 450 may include a payment processing module 451 and a payment signal reception module 453.

The payment processing module 451 may perform payment for a service or goods based on the payment signal received from the electronic device 101.

The payment signal reception module 453 may receive the payment signal from the electronic device 101. For example, the payment signal reception module 453 may receive a payment signal transmitted by at least one of MST and NFC. Meanwhile, the payment signal reception module 453 may be the afore-described communication interface 170 or communication module 220.

While the POS device 450 provided in a shop is functionally connected to a sign pad that receives a user's signature, the sign pad is not shown in the embodiment of the present disclosure because the embodiment of the present disclosure is related to omission of an operation for entering a user's signature through the sign pad.

Each of the payment service server 420, the finance server 430, and the purchase server 440 may be configured as one or more servers. Further, the payment service server 420, the finance server 430, and the purchase server 440 may be integrated into one server.

Now, a description will be given of an electronic payment operation of the electronic payment system 40 based on the above description.

In operation 481, the electronic device 101 may request a token for electronic payment to the payment service server 420. Herein, the electronic device 101 may execute an electronic payment application for electronic payment, and perform a user authentication operation.

In operation 482, the payment service server 420 may request the token to the finance server 430 according to the token request received from the electronic device 101.

In operation 483, the finance server 430 may obtain the token and transmit the obtained token to the payment service server 420, in response to the token request.

In operation 484, the payment service server 420 may transmit the received token to the electronic device 101.

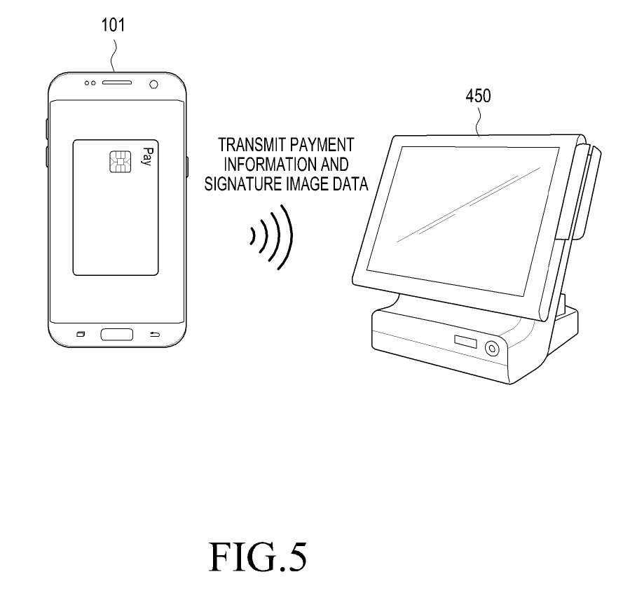

In operation 485, the electronic device 101 may transmit payment information including a token corresponding to a user-selected payment means (for example, a credit card) and signature image data for electronic payment to the POS device 450. The signature image data may include at least one of signature image of a user's signature image and/or a signature code corresponding to the signature image, which will be described later with reference to FIG. 5.

Meanwhile, to make payment using the electronic device 101, a payment means (for example, a credit card) needs to be registered to a payment application service (for example, Samsung Pay). To register the payment means, the user's signature needs to be registered along with registration information (a primary account number (PAN) such as a card security code (CVV)) about the payment means (subject to change according to the policy of the payment application service).

The user's signature may be entered by a touch input or a pen input. Upon completion of registration of the payment means, an image of the signature input by the user may be stored in at least one of a terminal or an external server (the payment service server, the finance server, the purchase server, or the like).

According to an embodiment of the present disclosure, a signature input process requested during payment may be simplified using the signature input by the user during registration of the payment means. For example, the image of the user's signature, which has been required to be registered and stored in the terminal or the external server during initial registration of the payment means (the credit card) in the payment application, may be used. More specifically, if payment is performed by NFC, the signature image data transmitted in operation 485 may be the data of the signature image data stored in the electronic device 101 along with the progress of registration of the credit card. On the other hand, if payment is performed by MST, the signature image data transmitted in operation 485 may be the signature code corresponding to the signature image stored in the electronic device 101 or the finance server 430 along with the progress of registration of the credit card. The signature code may be issued from the finance server 430 in real time during payment, or may be preliminarily issued from the finance server 430 and stored in the electronic device 101.

Meanwhile, a token may not be issued during each payment in a payment service of a specific country. In this case, the operation for requesting a token and receiving the token from the payment service server 420 by the electronic device 101 may be skipped or replaced with another operation. For example, after a token issued by registering a payment means (a credit card) to a payment application is stored in the electronic device 101, payment may be requested using the stored token. Therefore, when a user requests payment, a token is not requested to a server in a specific country (for example, the U.S.), and thus the electronic device 101 may proceed payment without accessing the payment service server 420.

In addition, two tokens (a token for MST payment and a token for NFC payment) may be requested and issued at one time in a specific country.

In operation 486, the POS device 450 may request the purchase server 440 to verify whether payment is available, using the payment information received from the electronic device 101. The POS device 450 may request the signature image according to the received signature image data.

In operation 487, the purchase server 440 may request the finance server 430 whether the payment is available.

In operation 488, the finance server 430 may determine whether the payment is available using the payment information in response to the payment availability verification request. If the purchase server 440 determines that the payment is available, the purchase server 440 may transmit a payment positive response signal. Meanwhile, if the purchase server 440 determines that the payment is not available, the purchase server 440 may transmit a payment negative availability verification request response signal.

In operation 489, the purchase server 440 may request a signature image to the payment service server 420 based on the received signature image data.

For example, the purchase server 440 may request a signature image corresponding to the signature code included in the received signature image data.

In operation 490, the payment service server 420 may obtain signature image data of the signature image based on the received signature image data, and transmit the signature image data to the purchase server 440.

According to various embodiments of the present disclosure, the signature image data may be stored in the purchase server 440 or the finance server 430.

In operation 491, the purchase server 440 may transmit the payment availability verification request response signal received from the finance server 430 to the POS device 450. The purchase server 440 may also transmit the signature image data received from the payment service server 420 to the POS device 450. Accordingly, the POS device 450 may perform payment for a service or goods using the payment information received from the electronic device 101, and use a signature for payment in performing the payment without receiving the user's signature additionally.

FIG. 5 is a diagram illustrating example transmission of payment information and signature image data for electronic payment in an electronic device according to an example embodiment of the present disclosure.

Referring to FIG. 5, the electronic device 101 may transmit payment information and signature image data for electronic payment to the POS device 450.

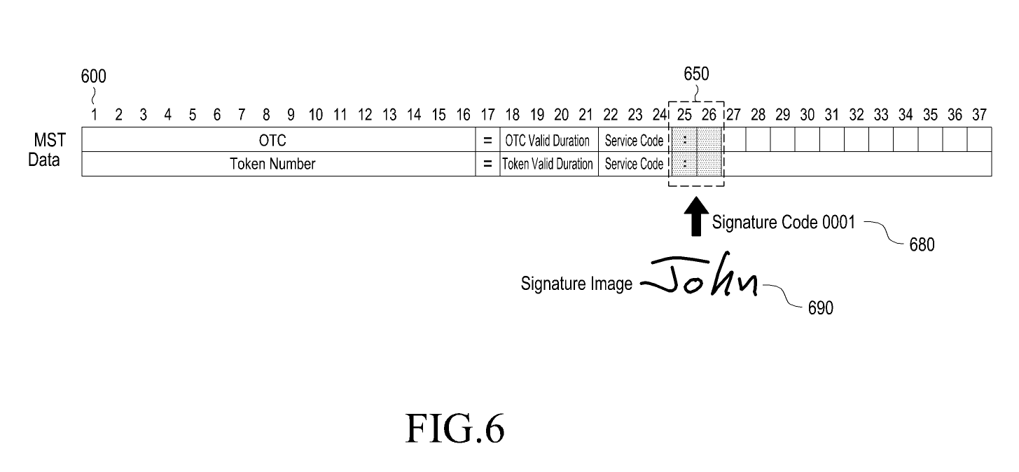

For example, the electronic device 101 may transmit to the POS device 450 MST data including a signature code corresponding to a user's signature image, configured in conformance to MST, which will be described in greater detail below with reference to FIG. 6.

FIG. 6 is a diagram illustrating an example MST data structure according to an example embodiment of the present disclosure.

Referring to FIG. 6, MST data 600 may include various types of data for payment. For example, the MST data 600 may include information about at least one of a one time card number (OTC), a token number, an OTC valid duration, a token valid duration, and a service code in a plurality of fields. The MST data 600 may further include a signature code 680 such as [0001] in a reserved field. The signature code 680 is a code corresponding to a signature image, which may be a reference code with which to obtain the signature image.

For example, when the electronic device 101 generates the MST data 600, the electronic device 101 may inset the signature code 680, [0001] corresponding to a signature image 690 in reserved fields 650 of the MST data 600. The reserved fields 650 of the MST data 600, in which the signature code is inserted, may be fields 25 and 26 of MST Track 2 Data. However, fields at various positions may be used for insertion of a signature code according to an MST payment policy or the structure of the MST data 600.

Meanwhile, the MST data 600 may be configured in a track 1 data format or a track 2 data format.

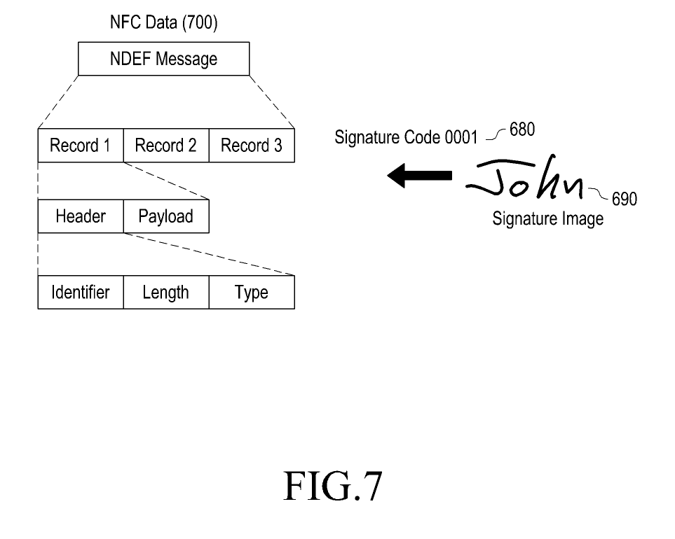

While it has been described with reference to FIG. 6 that a code corresponding to a user's signature image, instead of the signature image, is transmitted (radiated) by MST, the electronic device 101 may transmit the user's signature image itself (for example, an encrypted image file) to the POS device 450 by NFC in an embodiment of the present disclosure, which will be described below with reference to FIG. 7.

FIG. 7 is a diagram illustrating an example NFC data structure according to an example embodiment of the present disclosure.

Referring to FIG. 7, NFC data 700 may include various types of data for payment. For example, the NFC data 700 may include an NFC forum data exchange format (NDEF) message, and the NDEF message may include a plurality of records carrying various types of payment-related data. Each of the records may include a header and payload, and the header may include information about a payload length, and a payload ID. The NFC data 700 may include signature image data of a signature image in a partial area.

For example, when generating the NFC data 700, the electronic device 101 may insert signature image data of the signature image 690 in a partial area of the NFC data 700. Various partial areas of the NFC data 700 may be available for insertion of the signature image data according to the structure of the NFC data 700.

The above-descried payment signal transmission methods and data structures of a payment signal are purely examples, which should not be construed as limiting the present disclosure. Accordingly, various methods and data structures are applicable according to user or designer selection.

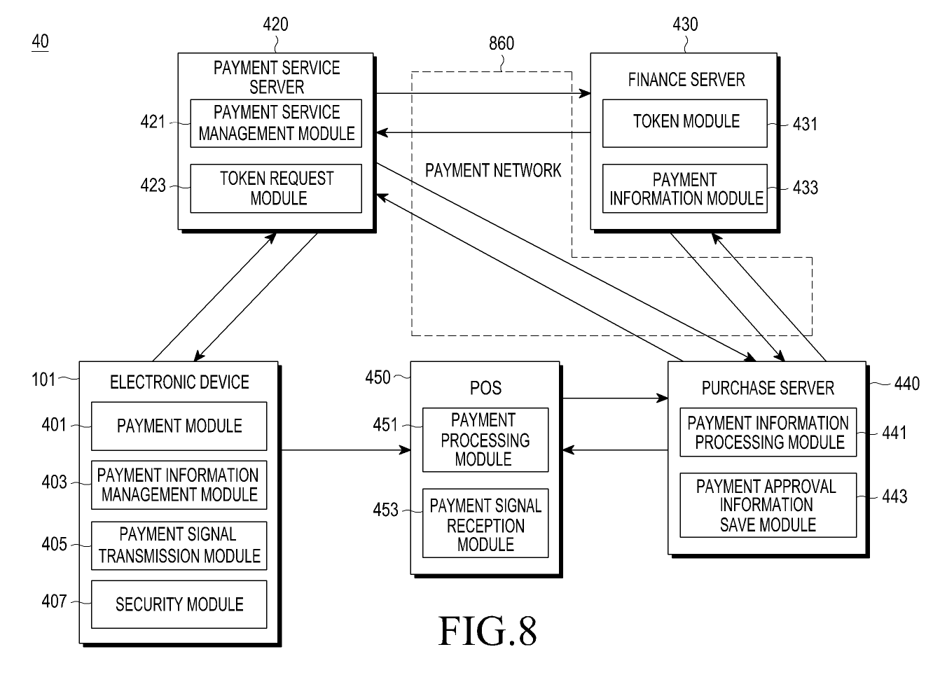

According to an embodiment, the electronic payment system 40 may transmit and receive payment-related data through a payment network 860, which will be described in greater detail below with reference to FIG. 8.

FIG. 8 is a diagram illustrating an example electronic payment system according to an example embodiment of the present disclosure.

Referring to FIG. 8, the payment service server 420, the finance server 430, and the purchase server 440 may interact with each other through the payment network 860 during communication between them.

According to an embodiment, the payment network 860 may include a network related to a financial institute or a card company. For example, the payment network 860 may include, for example, VisaNet.

The payment network 860 may be included in the previously described network 162. According to an embodiment, the payment network 860 may be isolated from other networks serving other purposes, thus providing high-level security. Therefore, according to an embodiment of the present disclosure, when transmitting payment-related data requiring high-level security, the electronic payment system 40 may use an external network server (for example, a key management service server or a fast identify online server) interacting with the payment network 860.

Registration of payment information and a signature image according to an embodiment will be described in greater detail below.

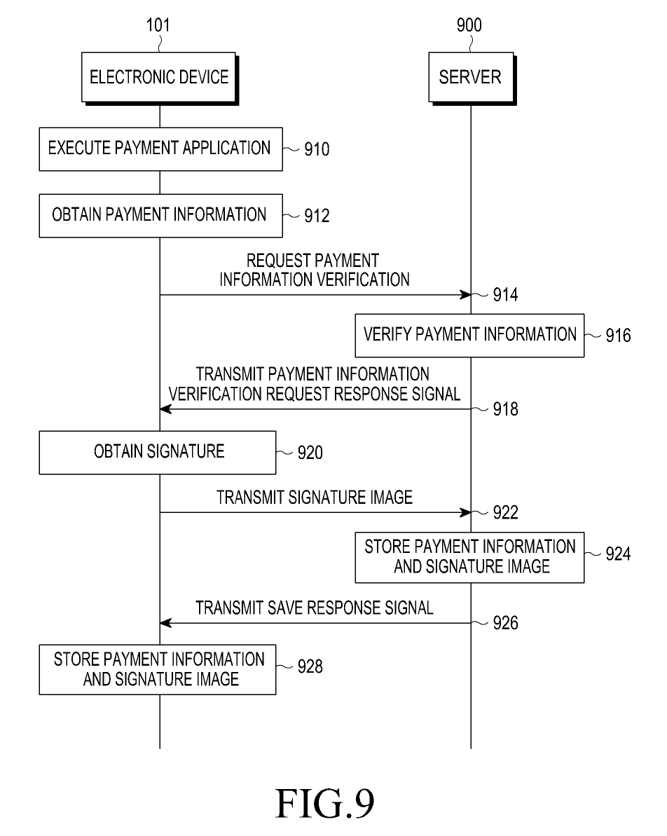

FIG. 9 is a sequence diagram illustrating an example signal flow for registration of payment information according to an example embodiment of the present disclosure.

In operation 910, the electronic device 101 may execute a payment application. For example, the electronic device 101 may execute the payment application in response to a payment application execution input.

In operation 912, the electronic device 101 may obtain payment information for use in payment (for example, information about a payment means including a credit card). The payment information may include card information (a PAN, an expiry date, a CVV, or the like), account information, and so on.

In operation 914, the electronic device 101 may request a server 900 to verify whether the obtained payment information is valid. The server 900 may be at least one of the foregoing payment service server 420, finance server 430, and purchase server 440.

In operation 916, the server 900 may determine whether the received payment information is valid.

In operation 918, the server 900 may transmit a payment information verification signal to the electronic device 101. For example, if the payment information is valid, the server 900 may transmit to the electronic device 101 a payment information verification signal indicating that the payment information is valid. On the other hand, if the payment information is not valid, the server 900 may transmit to the electronic device 101 a payment information verification signal indicating that the payment information is not valid. The case in which the payment information is valid will be described below.

In operation 920, the electronic device 101 may obtain a user's signature.

The user's signature obtained in operation 920 may be requested to register the payment means to be used by the user to the payment application, and may not be requested according to a change of the service policy of the payment application or may be replaced with a different type (for example, biometric authentication).

In operation 922, the electronic device 101 may transmit a signature image of the obtained user's signature to the server 900.

In operation 924, the server 900 may store the payment information and the signature image.

In operation 926, as the server 900 stores the payment information and the signature image, the server 900 may transmit a save response signal to the electronic device 101.

In operation 928, the electronic device 101 may store the payment information and the signature image. The electronic device 101 may store the payment information and the signature image in the security module 407. The electronic device 101 may store the payment information and only a code corresponding to the signature image (for example, the signature code illustrated in FIG. 6).

For example, the server 900 may generate a signature code from the signature image received from the electronic device 101, and build a database (DB) including user accounts, signature images, and signature codes. Then, the electronic device 101 may receive the signature code from the server 900, and store the signature code in a security area (for example, a container provided by KNOX) in such a manner that the received signature code may be mapped to at least one of the payment information, a user account, and the signature image.

The user may register a payment means (for example, a credit card) issued by the name of the user or another person to a payment application by the above operation. Upon completion of registration of the payment means to the payment application, the user may execute the payment application, select one of the registered payment means, and request payment by the selected payment means.

A payment operation of the electronic payment system 40 according to an embodiment will be described in greater detail below.

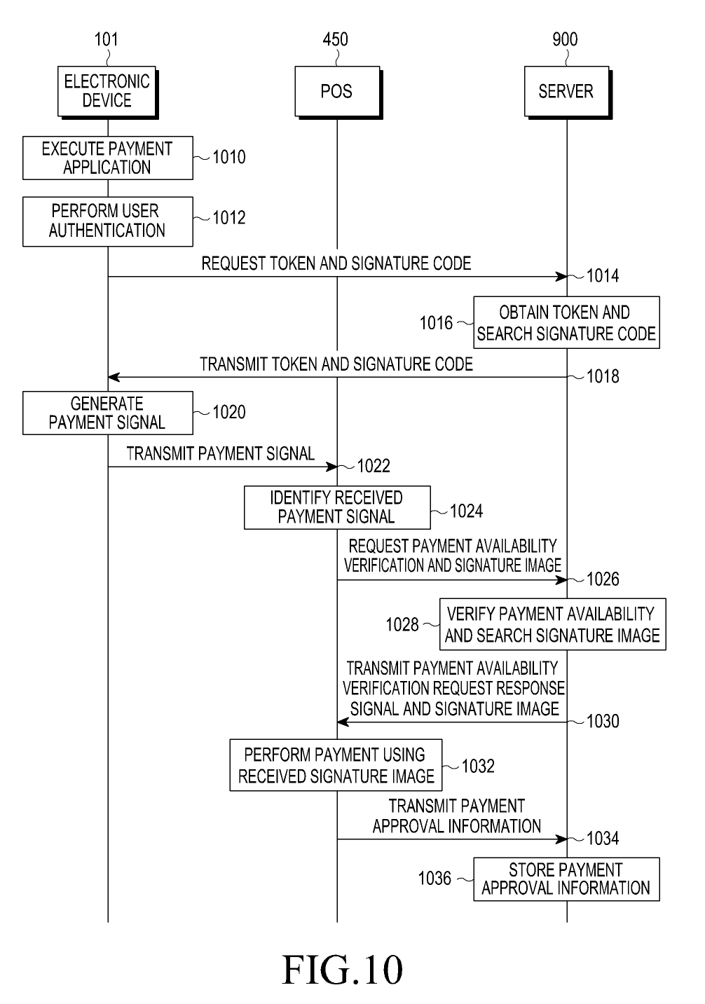

FIG. 10 is a sequence diagram illustrating an example signal flow for an example payment operation according to an example embodiment of the present disclosure.

Referring to FIG. 10, in operation 1010, the electronic device 101 may execute a payment application. For example, the electronic device 101 may execute the payment application based on a user input for execution of the payment application. In another example, upon receipt of a signal for information related to execution of the payment application or promotion of the payment application (for example, an advertisement, a discount coupon, or product recommendation), the electronic device 101 may execute the payment application. The signal for execution of the payment application may be received from a data network, the POS device 450, a transmitter related to the POS device 450, a beacon, or the like.

In operation 1012, the electronic device 101 may perform user authentication for payment. For example, the electronic device 101 may perform user authentication for payment using biometric information. The biometric information may include information about at least one of a user's fingerprint, iris, facial image, voice, heartbeat, or blood pressure.

In an embodiment, the electronic device 101 may recognize the biometric information of the user and perform user authentication based on the recognized biometric information using the biometric sensor 240I. In an embodiment, the biometric information-based user authentication may be performed using at least one of input biometric information about the user, biometric information registered in the electronic device 101, or biometric information registered in an external server (for example, a fast identity online (FIDO) server). In another embodiment, the electronic device 101 may perform user authentication by receiving various types of passwords.

In operation 1014, the electronic device 101 may request a token and a signature code for the authenticated user to the server 900.

In operation 1016, the server 900 may obtain the token for the authenticated user and search for the signature code for the authenticated user. The obtained token may be a one-time token or a token valid for a predetermined time, and may be encrypted. The signature code may also be a one-time signature code or a signature code valid for a predetermined time, and may be encrypted.

In operation 1018, the server 900 may transmit the obtained token and the searched signature code to the electronic device 101.

In operation 1020, the electronic device 101 may generate a payment signal including the received token and signature code.

In operation 1022, the electronic device 101 may transmit the generated payment signal to the POS device 450.

In operation 1024, the POS device 450 may identify the received payment signal. For example, the POS device 450 may identify the payment information and the signature code included in the received payment signal.

In operation 1026, the POS device 450 may request payment availability verification based on the payment information and a signature image corresponding to the signature code to the server 900.

In operation 1028, the server 900 may determine whether payment is available based on the received payment information, and search for the signature image corresponding to the signature code. For example, the server 900 may determine whether the price of a service or goods to be paid by the POS device 450 is payable, using the received payment information. The server 900 may obtain signature image data by searching for the signature image corresponding to the received signature code.

In operation 1030, the server 900 may transmit a payment availability verification request response signal and the signature image data (for example, the signature image) to the POS device 450. On the other hand, if the server 900 determines that the payment is not available, the server 900 may transmit a negative payment availability verification request response signal to the POS device 450. When transmitting the negative payment availability verification request response signal, the POS device 450 may not transmit the signature image.

In operation 1032, upon receipt of the payment availability verification request response signal, the POS device 450 may perform payment using the payment information, and the signature image corresponding to the signature image data. Therefore, the POS device 450 may proceed the payment without receiving a user's signature from the user through an additional device (for example, a sign pad).

In operation 1034, the POS device 450 may transmit payment approval information to the server 900 according to the performed payment. The payment approval information may include information about a slip for which payment has been approved. In an embodiment, if payment approval is completed and thus a payment slip (for example, a payment receipt) is provided to the user, the signature image received from the server 900 may be included (for example, printed) in the payment slip.

In operation 1036, the server 900 may store the received payment approval information.

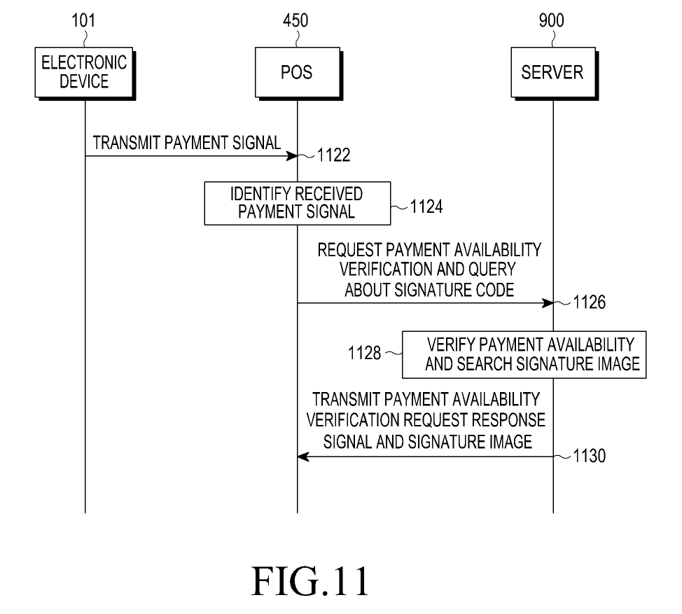

On the other hand, if the POS device 450 is not capable of recognizing the signature code, the POS device 450 may transmit a query about the signature code to the server 900 in operation 1024. Upon receipt of a specific code, the POS device 450 may be configured to query the server 900, which will be described in greater detail below with reference to FIG. 11.

FIG. 11 is a sequence diagram illustrating an example signal flow for an example operation for querying about a signature code according to an example embodiment of the present disclosure.

Referring to FIG. 11, the electronic device 101 may transmit a payment signal to the POS device 450 in operation 1122. In operation 1124, the POS device 450 may identify the received payment signal. If the POS device 450 is not capable of recognizing a signature code included in the payment signal, the POS device 450 may query the server 900 about the signature code. Further, the POS device 450 may be configured to query the server 900 about an unrecognizable code. For example, if the POS device 450 is not capable of recognizing the signature code included in the payment signal, the POS device 450 may query the server 900 for the unrecognizable signature code.

In operation 1126, the POS device 450 may request the server 900 to verify whether payment is available, and query the server 900 about the signature code.

In operation 1128, the server 900 may determine whether the payment is available, and search for a signature image corresponding to the signature code query. Thus, the server 900 may obtain signature image data corresponding to the signature code.

In operation 1130, the server 900 may transmit a payment availability verification request response signal and the searched signature image data to the POS device 450.

Thus, the POS device 450 may obtain the data of the signature image data from the server 900.

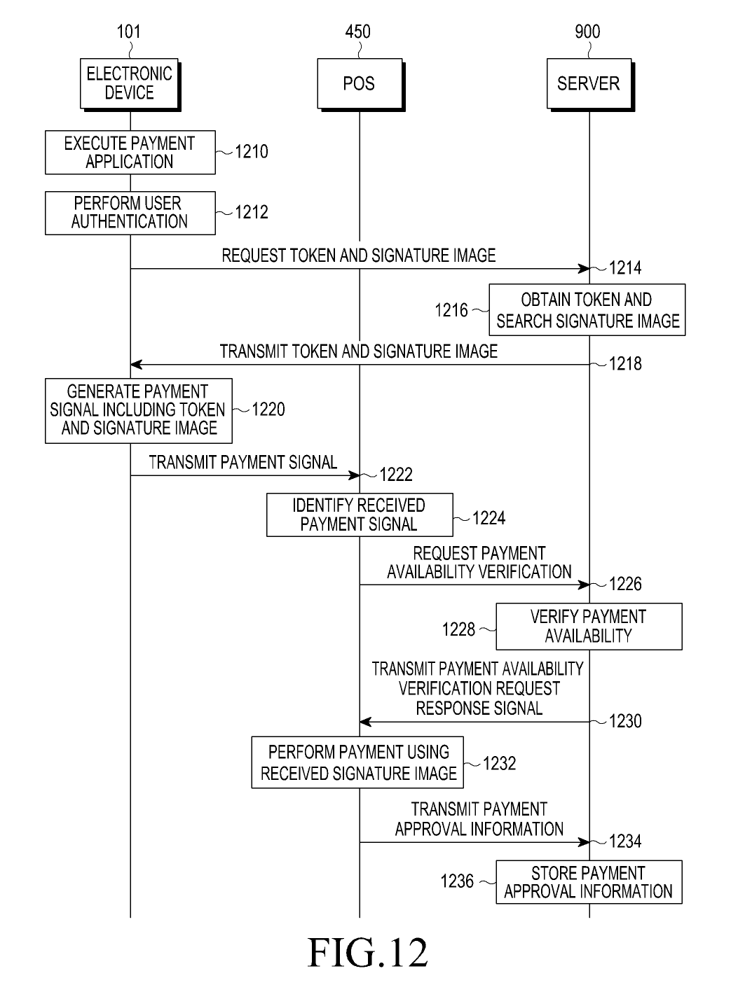

According to an embodiment, the electronic device 101 may transmit the signature image directly to the POS device 450, which will be described in greater detail below with reference to FIG. 12.

FIG. 12 is a sequence diagram illustrating an example signal flow for an example method for operating the electronic payment system 40 according to an example embodiment of the present disclosure.

Referring to FIG. 12, in operation 1210, the electronic device 101 may execute a payment application. For example, the electronic device 101 may execute the payment application based on a user input for execution of the payment application. In another example, upon receipt of a signal for execution of the payment application, the electronic device 101 may execute the payment application. The signal for execution of the payment application may be received from a data network, the POS device 450, a transmitter related to the POS device 450, a beacon, or the like.

In operation 1212, the electronic device 101 may perform user authentication for payment. For example, the electronic device 101 may perform user authentication for payment using biometric information. The biometric information may include information about at least one of a user's fingerprint, iris, facial image, voice, heartbeat, or blood pressure.

In an embodiment, the electronic device 101 may recognize the biometric information of the user and perform user authentication based on the recognized biometric information using the biometric sensor 240I. In another embodiment, the electronic device 101 may perform user authentication by receiving various types of passwords.

In operation 1214, the electronic device 101 may request a token and a signature image for the authenticated user to the server 900.

In operation 1216, the server 900 may obtain the token for the authenticated user and search for the signature image for the authenticated user. The obtained token may be a one-time token or a token valid for a predetermined time, and may be encrypted. The server 900 may generate signature image data of the searched signature image. The generated signature image data may be one-time data or data valid for a predetermined time, and may be encrypted.

In operation 1218, the server 900 may transmit the obtained token and signature image data to the electronic device 101.

In operation 1220, the electronic device 101 may generate a payment signal including the received token and signature image data. The electronic device 101 may further include a signature add code indicating inclusion of the signature image data in the payment signal.

In operation 1222, the electronic device 101 may transmit the generated payment signal to the POS device 450.

In operation 1224, the POS device 450 may identify the received payment signal. For example, the POS device 450 may identify the payment information and the signature image data included in the received payment signal. The POS device 450 may further identify the signature add code included in the payment signal. Thus, the POS device 450 may determine that the signature image data is included in the payment signal.

In operation 1226, the POS device 450 may request payment availability verification based on the payment information to the server 900.

In operation 1228, the server 900 may determine whether the payment is available based on the received payment information. For example, the server 900 may determine whether the price of a service or goods to be paid by the POS device 450 is payable, using the received payment information. The server 900 may also determine whether the received payment information matches the signature image.

In operation 1230, the server 900 may transmit a payment availability verification request response signal to the POS device 450. On the other hand, if the server 900 determines that the payment is not available, the server 900 may transmit a negative payment availability verification request response signal to the POS device 450.

In operation 1232, upon receipt of the payment availability verification request response signal, the POS device 450 may perform payment using the payment information and the signature image. Therefore, the POS device 450 may not receive a user's signature separately.

In operation 1234, the POS device 450 may transmit payment approval information to the server 900 according to the performed payment. The payment approval information may include information about a slip for which payment has been approved.

In operation 1236, the server 900 may store the received payment approval information.

While it has been described in the foregoing embodiment that the electronic device 101 may provide a signature code or a signature image to the POS device 450, this operation may be determined according to the type or property (for example, a data transmission bandwidth) of a component that transmits a payment signal to the POS device 450 in the electronic device 101.

For example, if the electronic device 101 uses an MST module, the electronic device 101 may transmit a signature code to the POS device 450. If the electronic device 101 uses an NFC module, the electronic device 101 is capable of transmitting a code of a signature image as well as the signature image. Thus, the electronic device 101 may transmit at least one of the signature image or the signature code to the POS device 450.

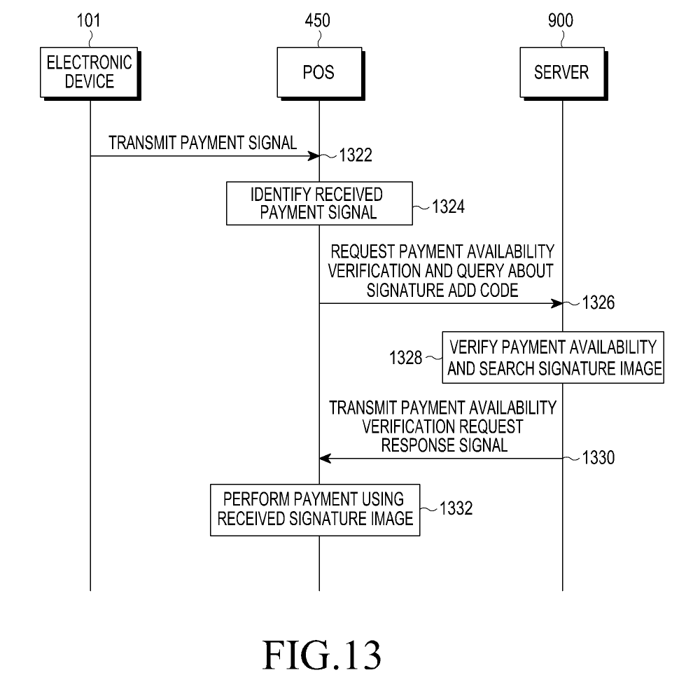

On the other hand, if the POS device 450 is not capable of recognizing the signature image data, the POS device 450 may transmit a query about at least one of the signature image data and the signature add code to the server 900 in operation 1224. Upon receipt of a specific code, for example, a signature add code, the POS device 450 may be configured to query the server 900, which will be described in greater detail below with reference to FIG. 13.

FIG. 13 is a sequence diagram illustrating an example signal flow for an example operation for querying about a signature add code according to an example embodiment of the present disclosure.

Referring to FIG. 13, the electronic device 101 may transmit a payment signal to the POS device 450 in operation 1322. In operation 1324, the POS device 450 may identify the received payment signal. If the POS device 450 is not capable of recognizing a signature add code included in the payment signal, the POS device 450 may query the server 900 about the signature add code. Further, the POS device 450 may be configured to query the server 900 about an unrecognizable code. For example, if the POS device 450 is not capable of recognizing the signature add code included in the payment signal, the POS device 450 may query the server 900 about the unrecognizable signature add code.

In operation 1326, the POS device 450 may request the server 900 to verify whether payment is available, and query the server 900 about the signature add code.

In operation 1328, the server 900 may verify the payment availability and search for the signature image, and generate a response signal indicating addition of a signature image to the payment signal, in response to the signature add code query. Thus, the response signal generated from the server 900 may be a signal indicating whether the payment is available and confirming the signature image. Further, the server 900 may determine whether the signature image is valid.

In operation 1330, the server 900 may transmit a payment availability verification request response signal indicating payment availability verification request response signal and confirming the signature image to the POS device 450.

In operation 1332, the POS device 450 may perform payment using the received signature image and the signature image included in the payment signal, as confirmed by the server 900.

According to an embodiment, the electronic device 101 may store at least one of payment information and signature image data in at least one of the memory 130 or 230 and the security module 407. Accordingly, the electronic device 101 may generate a payment signal using the stored payment information without requesting a token to the server 900. Further, the electronic device 101 may generate the payment signal using the stored signature image data without requesting a signature code or a signature image to the server 900. This operation will be described in greater detail below.

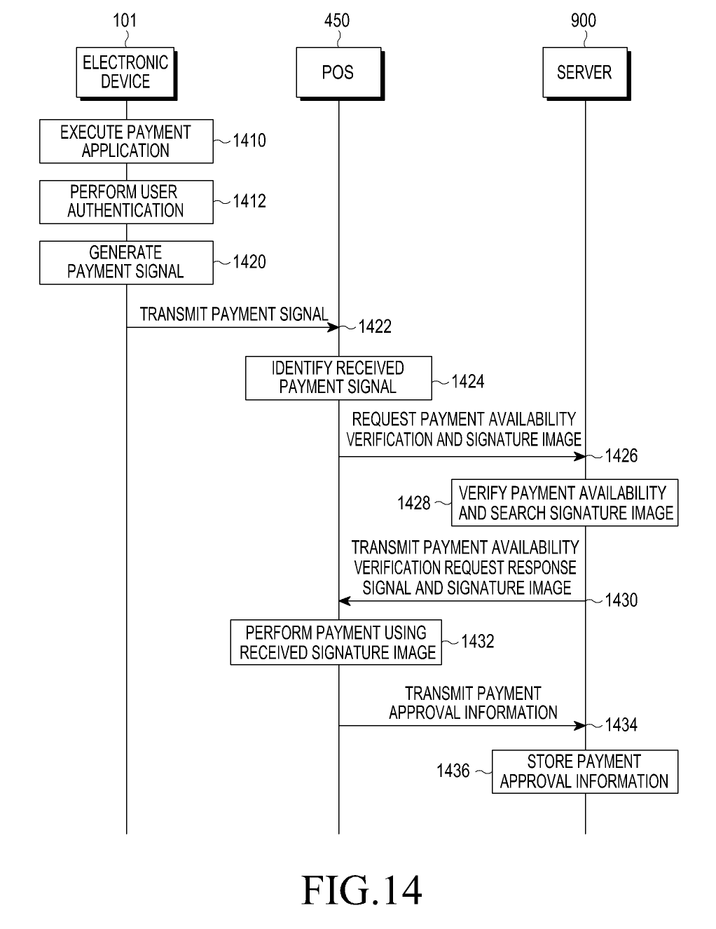

FIG. 14 is a sequence diagram illustrating an example signal flow for an example method for operating the electronic payment system according to an example embodiment of the present disclosure.

Referring to FIG. 14, in operation 1410, the electronic device 101 may execute a payment application. For example, the electronic device 101 may execute the payment application based on a user input for execution of the payment application. In another example, upon receipt of a signal for execution of the payment application, the electronic device 101 may execute the payment application. The signal for execution of the payment application may be received from the POS device 450 or a transmitter related to the POS device 450.

In operation 1412, the electronic device 101 may perform user authentication for payment. For example, the electronic device 101 may perform user authentication for payment using biometric information. The biometric information may include information about at least one of a user's fingerprint, iris, facial image, voice, heartbeat, or blood pressure.

In an embodiment, the electronic device 101 may recognize the biometric information of the user and perform user authentication based on the recognized biometric information using the biometric sensor 240I. In another embodiment, the electronic device 101 may perform user authentication by receiving various types of passwords.

In operation 1420, the electronic device 101 may generate a payment signal corresponding to the authenticated user input. For example, the electronic device 101 may generate a payment signal including payment information and a signature code, using the payment information and signature image data stored in at least one of the memory 130 or 230 and the security module 407.

In operation 1422, the electronic device 101 may transmit the generated payment signal to the POS device 450.

In operation 1424, the POS device 450 may identify the received payment signal. For example, the POS device 450 may identify the payment information and the signature code included in the received payment signal.

In operation 1426, the POS device 450 may request payment availability verification and a signature image corresponding to the signature code to the server 900. Meanwhile, if the POS device 450 is not capable of recognizing the signature code, the POS device 450 may be configured to query the server 900 about the signature code, which has been described before in detail and thus will not be described herein.

In operation 1428, the server 900 may determine whether the payment is available based on the received payment information, and search for the signature image corresponding to the signature code. For example, the server 900 may determine whether the price of a service or goods to be paid by the POS device 450 is payable, using the received payment information. The server 900 may obtain signature image data by searching for the signature image corresponding to the received signature code.

In operation 1430, the server 900 may transmit a payment availability verification request response signal and the signature image data to the POS device 450. On the other hand, if the server 900 determines that the payment is not available, the server 900 may transmit a negative payment availability verification request response signal to the POS device 450.

In operation 1432, upon receipt of the payment availability verification request response signal, the POS device 450 may perform payment using the payment information and the signature image corresponding to the signature image data. Therefore, the POS device 450 may not receive a user's signature separately.

In operation 1434, the POS device 450 may transmit payment approval information to the server 900 according to the performed payment. The payment approval information may include information about a slip for which payment has been approved.

In operation 1436, the server 900 may store the received payment approval information.

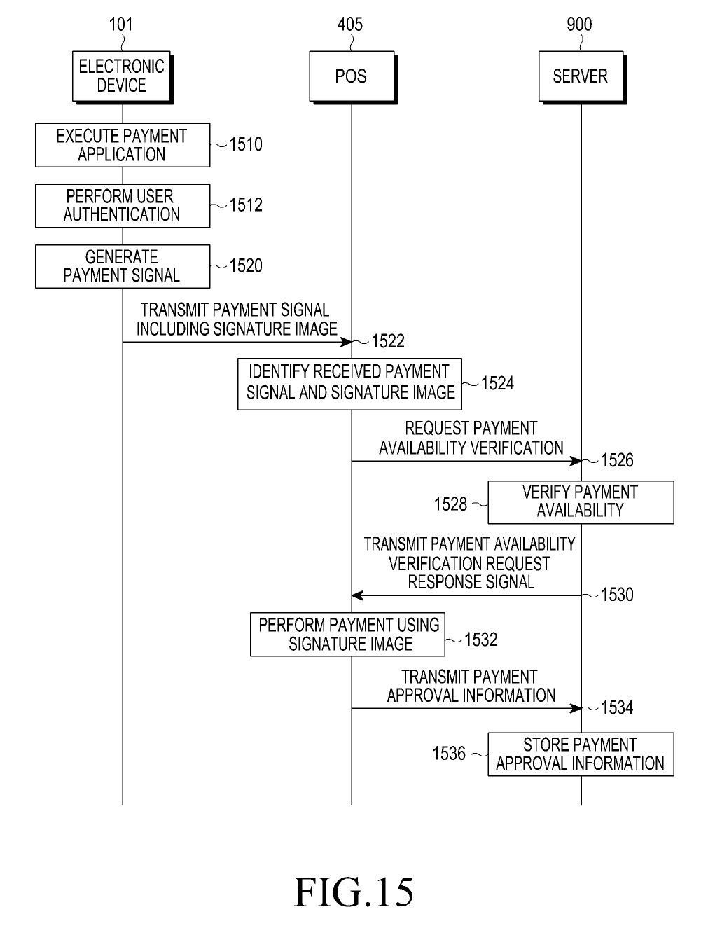

Meanwhile, if the electronic device 101 generates a payment signal including signature image of a signature image in operation 1420, the POS device 450 receiving the payment signal may skip the operation for requesting a signature image corresponding to a signature code to the server 900, which will be described in greater detail below with reference to FIG. 15.

FIG. 15 is a sequence diagram illustrating an example signal flow for a method for operating the electronic payment system according to an example embodiment of the present disclosure.

Referring to FIG. 15, in operation 1510, the electronic device 101 may execute a payment application. For example, the electronic device 101 may execute the payment application based on a user input for execution of the payment application. In another example, upon receipt of a signal for execution of the payment application, the electronic device 101 may execute the payment application. The signal for execution of the payment application may be received from the POS device 450 or a transmitter related to the POS device 450.

In operation 1512, the electronic device 101 may perform user authentication for payment. For example, the electronic device 101 may perform user authentication for payment using biometric information. The biometric information may include information about at least one of a user's fingerprint, iris, facial image, voice, heartbeat, or blood pressure.

In an embodiment, the electronic device 101 may recognize the biometric information of the user and perform user authentication based on the recognized biometric information using the biometric sensor 240I. In another embodiment, the electronic device 101 may perform user authentication by receiving various types of passwords.

In operation 1520, the electronic device 101 may generate a payment signal corresponding to the authenticated user input. For example, the electronic device 101 may generate a payment signal including payment information and signature image data, using the payment information and signature image data stored in at least one of the memory 130 or 230 and the security module 407. Further, the electronic device 101 may generate a payment signal further including a signature add code.

In operation 1522, the electronic device 101 may transmit the generated payment signal to the POS device 450.

In operation 1524, the POS device 450 may identify the received payment signal. For example, the POS device 450 may identify the payment information and the signature image data included in the received payment signal. The POS device 450 may further identify the signature add code included in the payment signal, and identify the signature image based on the identify signature add code.

In operation 1526, the POS device 450 may request payment availability verification based on the payment information to the server 900. The POS device 450 may also request the server 900 to verify whether the signature image is valid. Meanwhile, if the POS device 450 is not capable of recognizing the signature add code, the POS device 450 may be configured to query the server 900 about the signature add code. Thus, the POS device 450 may query the server 900 about the signature add code, which has been described before and thus will not be described herein.

In operation 1528, the server 900 may determine whether the payment is available based on the received payment information. For example, the server 900 may determine whether the price of a service or goods to be paid by the POS device 450 is payable, using the received payment information. In addition, the server 900 may determine whether the signature image is valid in response to the signature image verification request.

In operation 1530, the server 900 may transmit a payment availability verification request response signal to the POS device 450. On the other hand, if the server 900 determines that the payment is not available, the server 900 may transmit a negative payment availability verification request response signal to the POS device 450. Further, the server 900 may transmit a response indicating whether the signature image is valid to the POS device 450.

In operation 1532, upon receipt of the payment availability verification request response signal, the POS device 450 may perform payment using the payment information and the signature image corresponding to the signature image data. Therefore, the POS device 450 may not receive a user's signature separately.

In operation 1534, the POS device 450 may transmit payment approval information to the server 900 according to the performed payment. The payment approval information may include information about a slip for which payment has been approved.

In operation 1536, the server 900 may store the received payment approval information.

According to an embodiment, the electronic payment system 40 may be configured to make signature-free payment without receiving a user's signature. If a signature-free payment condition is satisfied, the electronic payment system 40 may perform payment without receiving a user's signature.

The signature-free payment condition may be a user account-based condition according to a setting for a user account, or a place-based condition according to a shop capable of signature-free payment.

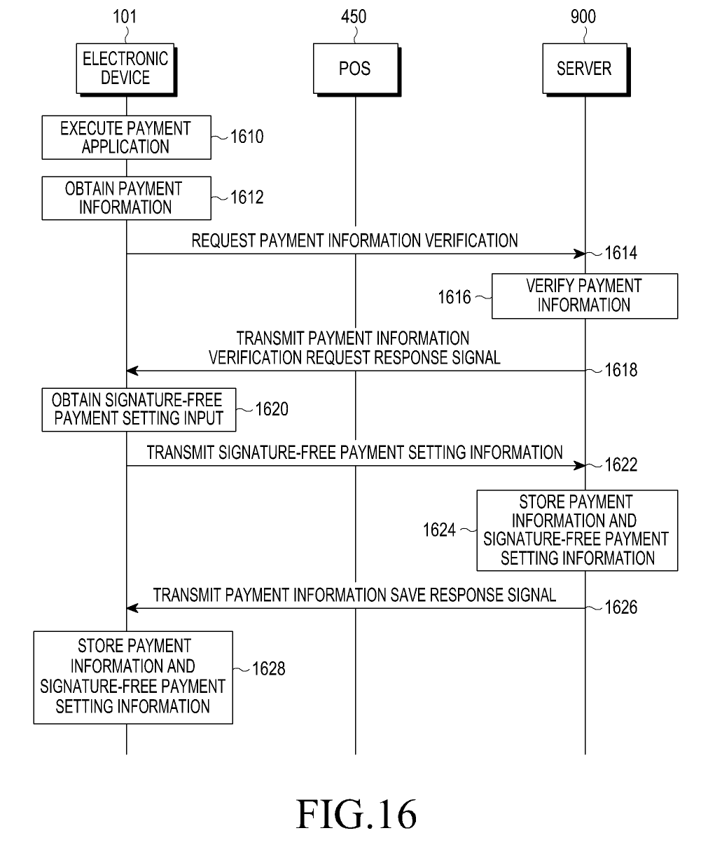

Signature-free payment setting will be described in greater detail below with reference to FIG. 16.

FIG. 16 is a sequence diagram illustrating an example signal flow for an example operation for setting signature-free payment according to an example embodiment of the present disclosure.

Referring to FIG. 16, the electronic device 101 may execute a payment application in operation 1610. For example, the electronic device 101 may execute the payment application in response to an input for execution of the payment application.

In operation 1612, the electronic device 101 may obtain payment information for use in payment. The payment information may be payment-related information such as card information and account information.

In operation 1614, the electronic device 101 may request the server 900 to verify whether the obtained payment information is valid. The server 900 may be at least one of the payment service server 420, the finance server 430, and the purchase server 440.

In operation 1616, the server 900 may determine whether the received payment information is valid.

In operation 1618, the server 900 may transmit a payment information verification signal to the electronic device 101. For example, if the payment information is valid, the server 900 may transmit to the electronic device 101 a payment information verification signal indicating that the payment information is valid. If the payment information is not valid, the server 900 may transmit to the electronic device 101 a payment information verification signal indicating that the payment information is not valid. The following description is given of the case where payment information is valid.

In operation 1620, when making payment according to the valid payment information, the electronic device 101 may obtain a signature-free payment setting input for payment without receiving a signature.

According to an embodiment, the electronic device 101 may obtain a signature-free payment setting input for setting signature-free payment, when payment is made based on a user account of a user corresponding to the obtained payment information. The electronic device 101 may obtain a setting input for various contents related to signature-free payment setting, for example, at least one of an amount payable without a signature, a payment place, and a signature-free payment setting duration. Therefore, the electronic device 101 may obtain a signature-free payment setting input that enables all payments to be signature-free, or a signature-free payment setting input that enables signature-free payment only when a predetermined payment condition is satisfied.

In operation 1622, the electronic device 101 may transmit signature-free payment setting information about the obtained signature-free payment setting input to the server 900.

In operation 1624, the server 900 may store the payment information and the signature-free payment setting information. Accordingly, the server 900 may store a database (DB) based on signature-free payment setting information.

In operation 1626, the server 900 may transmit a save response signal to the electronic device 101, as the payment information and the signature-free payment setting information are stored.

In operation 1628, the electronic device 101 may store the payment information and the signature-free payment setting information. The electronic device 101 may store the payment information and the signature-free payment setting information in the security module 407, and the signature-free payment setting information may be stored in the DB based on signature-free payment settings.

Meanwhile, the electronic device 101 may obtain a signature-free payment setting input during or after acquisition of payment information, and may obtain a change input for a signature-free payment setting.

A payment operation of the electronic payment system 40 according to an embodiment will be described in greater detail below.

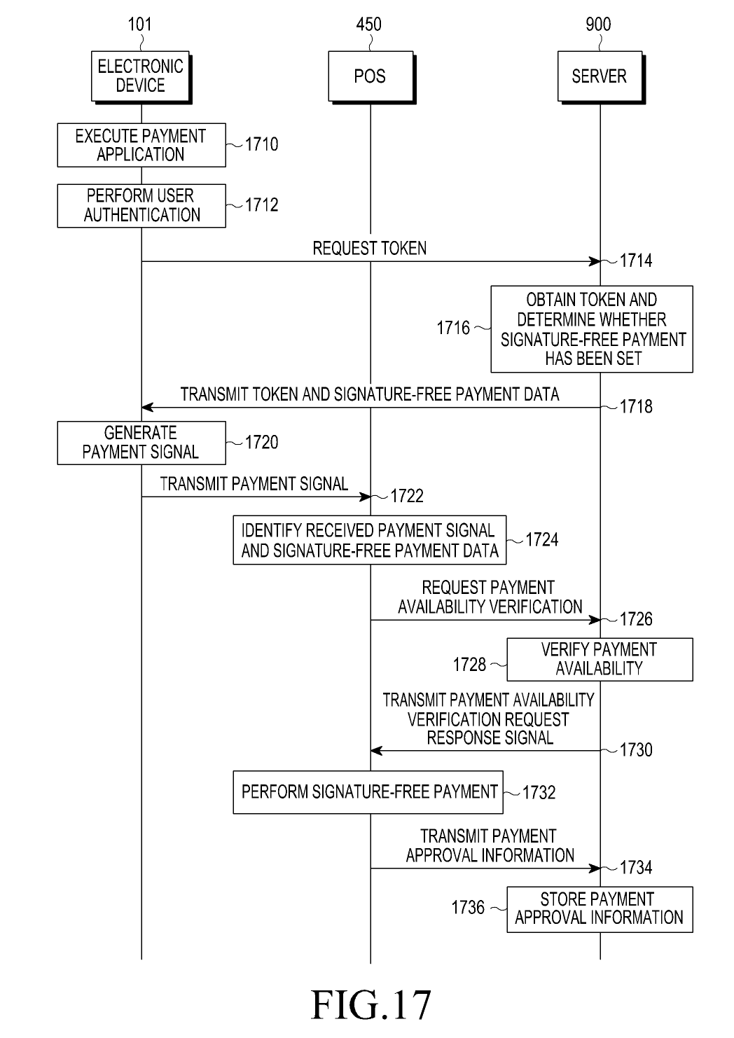

FIG. 17 is a sequence diagram illustrating an example signal flow for an example payment operation according to an example embodiment of the present disclosure.

Referring to FIG. 17, in operation 1710, the electronic device 101 may execute a payment application. For example, the electronic device 101 may execute the payment application based on a user input for execution of the payment application. In another example, upon receipt of a signal for execution of the payment application, the electronic device 101 may execute the payment application. The signal for execution of the payment application may be received from the POS device 450 or a transmitter related to the POS device 450.

In operation 1712, the electronic device 101 may perform user authentication for payment. For example, the electronic device 101 may perform user authentication for payment using biometric information. The biometric information may include information about at least one of a user's fingerprint, iris, facial image, voice, heartbeat, or blood pressure.

In an embodiment, the electronic device 101 may recognize the biometric information of the user and perform user authentication based on the recognized biometric information using the biometric sensor 240I. In another embodiment, the electronic device 101 may perform user authentication by receiving various types of passwords.

In operation 1714, the electronic device 101 may request a token for the authenticated user to the server 900.

In operation 1716, the server 900 may obtain the token for the authenticated user, and determine whether signature-free payment has been set for the authenticated user. If determining that signature-free payment has been set for the authenticated user, the server 900 may generate signature-free payment data. Further, the server 900 may determine whether a shop corresponding to the location of the electronic device 101 has subscribed to a signature-free service, based on location information about the electronic device 101. If determining that the shop corresponding to the location of the electronic device 101 has subscribed to the signature-free service, the server 900 may generate signature-free payment data.

The obtained token may be a one-time token or a token valid during a predetermined time, and may be encrypted. The signature-free payment data may be data that makes the POS device 450 perform signature-free payment.

In operation 1718, the server 900 may transmit the obtained token and signature-free payment data to the electronic device 101.

According to an embodiment, another server connected to the server 900 may transmit at least one of the token or the signature-free payment data. For example, another server may be a token service provider server, an issuer server, a trusted service management (TSM) server, or a key management service (KMS) server.

When a payment service is used in a specific country, after a token issued during card registration is stored in a terminal, payment may be requested using the stored token, without issuing a token at each payment.

For example, when a user requests payment in a specific country (for example, the U.S.), the electronic device 101 does not request a token to a server, and perform payment using a token stored in a predetermined storage area (for example, a security storage area such as a container of KNOX) of the electronic device 101 without accessing the server, under circumstances.

In an embodiment, therefore, a signature-free code is issued based on a user account (or a terminal). After the issued signature-free code is stored, payment may be requested using the stored token and signature-free code.

In another example, if a token is requested in a specific country (for example, China), the electronic device 101 may get two types of tokens (for example, an MST payment token and an NFC payment token) issued.

In an embodiment, therefore, the server 900 or an external server interworking with the server 900 may generate a plurality of signature-free codes corresponding to the number or types of issued tokens and transmit the signature-free codes to the electronic device 101. The electronic device 101 may transmit a signature-free code corresponding to an MST payment scheme and/or an NFC payment scheme to the POS device 450.

In another example, payment signals may be transmitted by operating an MST module and an NFC module simultaneously (or alternately) during payment in a specific country (for example, Korea). Therefore, in an embodiment, the electronic device 101 may transmit the payment signals simultaneously (or alternately) to the POS device 450 through the MST module and the NFC module, using one signature-free code received from the server 900 or an external server interworking with the server 900.

Meanwhile, if a shop visited by a user supports signature-free payment on its own, a POS device of the shop may not request signature data. In this case, the POS device 450 may not receive signature-free payment data from the electronic device 101 by interworking with the electronic device 101.

In operation 1720, the electronic device 101 may generate a payment signal including the received token and signature-free payment data. In operation 1722, the electronic device 101 may transmit the generated payment signal to the POS device 450.

In operation 1724, the POS device 450 may identify the received payment signal. For example, the POS device 450 may identify the payment information and the signature-free payment data included in the received payment signal.

In operation 1726, the POS device 450 may request payment availability verification based on the payment information to the server 900. The POS device 450 may also request the server 900 to verify whether the signature-free payment data is valid.

In operation 1728, the server 900 may determine whether payment is available based on the received payment information. For example, the server 900 may determine whether the price of a service or goods to be paid by the POS device 450 is payable, using the received payment information. In addition, the server 900 may determine whether the received signature-free payment data is valid.

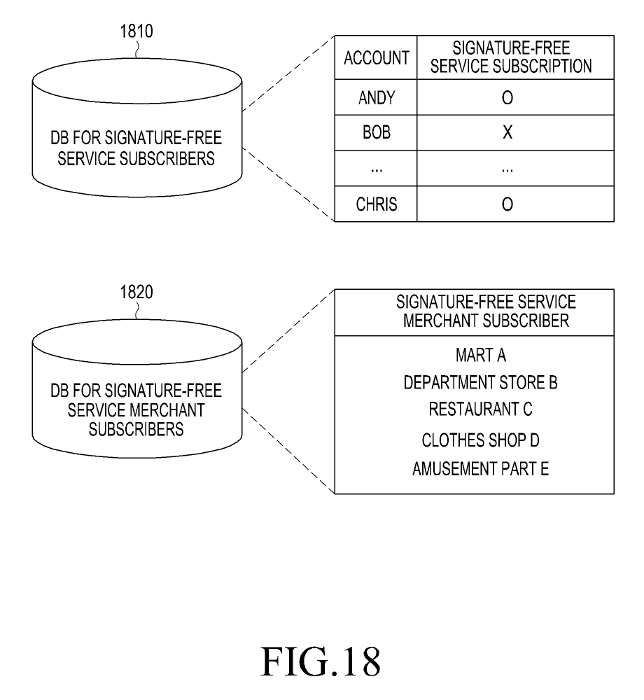

Meanwhile, if the server 900 does not determine whether signature-free payment has been set in operation 1716, the server 900 may determine whether signature-free payment is available based on the payment availability verification request. For example, the server 900 may determine whether a shop corresponding to the POS device 450 has subscribed to a signature-free service, based on information about the shop corresponding to the POS device that has requested payment availability verification. This will be described in greater detail below with reference to FIG. 18.

In operation 1730, the server 900 may transmit a payment availability verification request response signal to the POS device 450. On the other hand, if the server 900 determines that the payment is not available, the server 900 may transmit a negative payment availability verification request response signal to the POS device 450.

In operation 1732, upon receipt of the payment availability verification request response signal, the POS device 450 may perform payment using the payment information and the signature-free payment data. Therefore, the POS device 450 may not receive a user's signature separately.

In operation 1734, the POS device 450 may transmit payment approval information to the server 900 according to the performed payment. The payment approval information may include information about a slip for which payment has been approved.

In operation 1736, the server 900 may store the received payment approval information.

FIG. 18 is diagram illustrating example DBs related to signature-free payment according to an example embodiment of the present disclosure.

In an embodiment, the server 900 may verify information about an authenticated user and obtain a token corresponding to a verified user input. The server 900 may determine whether signature-free payment has been set for the authenticated user. For example, the server 900 may determine whether signature-free payment has been set for the authenticated user by determining whether the authenticated user is a signature-free service subscriber in a stored DB 1810 for signature-free service subscribers. The signature-free payment setting may refer, for example, to subscription to the signature-free service. In another example, the server 900 may determine whether signature-free payment has been set for the authenticated user by determining whether a shop corresponding to the location of the electronic device 101 has subscribed to the signature-free service, in a stored DB 1820 for signature-free service merchant subscribers.

In an embodiment, the server 900 may store the DB 1810 for signature-free service subscribers, and determine whether a user corresponding to a token request has subscribed to the signature-free service. For example, the server 900 may determine whether a user corresponding to a token request has subscribed to the signature-free service based on the DB 1810 for signature-free service subscribers. If the user corresponding to the token request has subscribed to the signature-free service, the server 900 may determine that signature-free payment is available, and if the user corresponding to the token request has not subscribed to the signature-free service, the server 900 may determine that signature-free payment is not available.

In another embodiment, the server 900 may store the DB 1820 for signature-free service merchant subscribers, and determine whether a shop corresponding to location information about the electronic device 101 requesting a token has subscribed to the signature-free service. For example, the server 900 may determine whether a shop corresponding to location information about the electronic device 101 has subscribed to the signature-free service, based on the DB 1820 for signature-free service merchant subscribers. If the shop corresponding to location information about the electronic device 101 has subscribed to the signature-free service, the server 900 may determine that signature-free payment is available. If the shop corresponding to location information about the electronic device 101 has not subscribed to the signature-free service, the server 900 may determine that signature-free payment is not available.

The server 900 may store the DB 1820 for signature-free service merchant subscribers. Upon receipt of a payment availability verification request from the POS device 450, the server 900 may determine whether a shop corresponding to the POS device 450 has subscribed to the signature-free service. For example, the server 900 may determine whether the requested shop has subscribed to the signature-free service, based on the DB 1820 for signature-free service merchant subscribers. If the shop corresponding to the POS device 450 has subscribed to the signature-free service, the server 900 may determine that signature-free payment is available. If the shop corresponding to the POS device 450 has not subscribed to the signature-free service, the server 900 may determine that a signature is required for payment. If payment is available without receiving a signature, the server 900 may transmit a later-described payment availability verification request response signal including signature-free payment data to the POS device 450.

A specific shop (for example, department store B) may request a user signature to a general user, whereas it may support signature-free payment to a user of a specific payment application service. Accordingly, in an embodiment, signature-free payment may be supported, referring to both the DBs 1810 and 1820, not one of them.

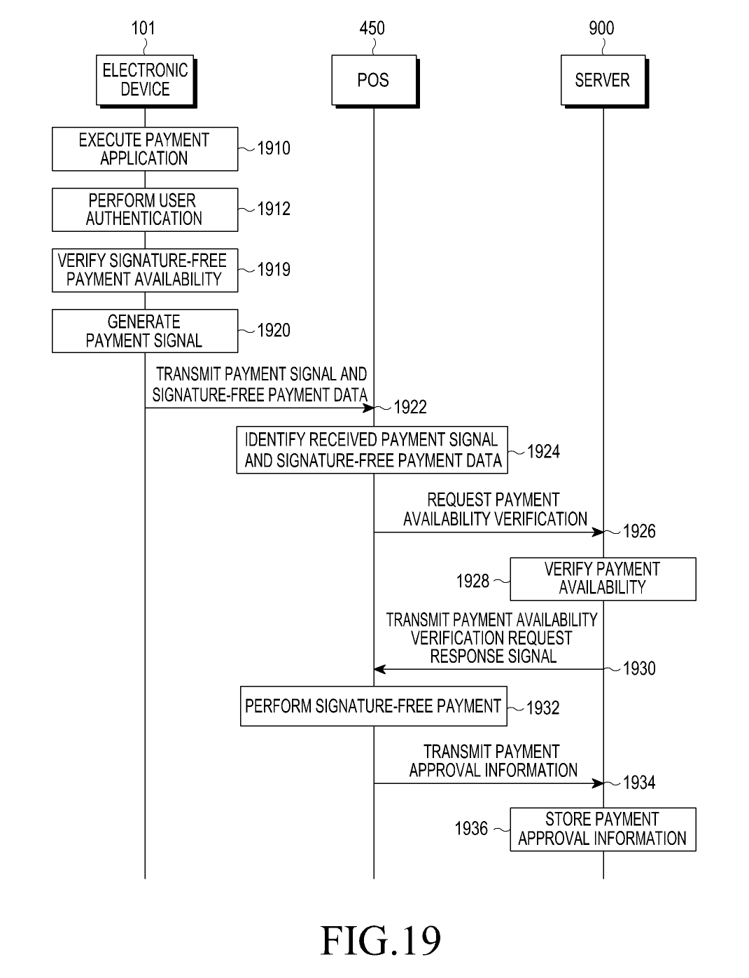

In an embodiment, the electronic device 101 may store at least one of payment information and signature-free payment setting information in at least one of the memory 130 or 230 and the security module 407. Therefore, when generating a payment signal, the electronic device 101 may generate the payment signal using the stored payment information without requesting a token to the server 900. Further, the electronic device 101 may generate signature-free payment data that leads to payment without a signature input, and transmit a payment signal including the generated signature-free payment data to the POS device 450, which will be described below with reference to FIG. 19.

FIG. 19 is a sequence diagram illustrating an example signal flow for an example payment operation according to an example embodiment of the present disclosure.

Referring to FIG. 19, in operation 1910, the electronic device 101 may execute a payment application. For example, the electronic device 101 may execute the payment application based on a user input for execution of the payment application. In another example, upon receipt of a signal for execution of the payment application, the electronic device 101 may execute the payment application. The signal for execution of the payment application may be received from the POS device 450 or a transmitter related to the POS device 450.

In operation 1912, the electronic device 101 may perform user authentication for payment. For example, the electronic device 101 may perform user authentication for payment using biometric information. The biometric information may include information about at least one of a user's fingerprint, iris, facial image, voice, heartbeat, or blood pressure.

In an embodiment, the electronic device 101 may recognize the biometric information of the user and perform user authentication based on the recognized biometric information using the biometric sensor 240I. In another embodiment, the electronic device 101 may perform user authentication by receiving various types of passwords.

In operation 1919, the electronic device 101 may determine whether signature-free payment is available.

For example, the electronic device 101 may determine whether an authenticated user has subscribed to a signature-free service based on the DB 1810 for signature-free service subscribers. If the authenticated user has subscribed to the signature-free service, the electronic device 101 may determine that signature-free payment is available.

In another example, the electronic device 101 may determine whether a shop corresponding to the location of the electronic device 101 has subscribed to the signature-free service, based on the DB 1820 for signature-free service merchant subscribers. If the shop corresponding to the location of the electronic device 101 has subscribed to the signature-free service, the server 900 may determine that signature-free payment is available.

In operation 1920, the electronic device 101 may generate a payment signal corresponding to the authenticated user input. For example, the electronic device 101 may generate a payment signal including payment information and signature-free payment data based on the payment information stored in at least one of the memory 130 or 230 and the security module 407, and the determination as to signature-free payment availability.

In operation 1922, the electronic device 101 may transmit the generated payment signal to the POS device 450.

In operation 1924, the POS device 450 may identify the received payment signal. For example, the POS device 450 may identify the payment information and the signature-free payment data included in the received payment signal.

In operation 1926, the POS device 450 may request payment availability verification based on the payment information to the server 900. The POS device 450 may also request the server 900 to verify whether the signature-free payment data is valid.

In operation 1928, the server 900 may determine whether payment is available based on the received payment information. For example, the server 900 may determine whether the price of a service or goods to be paid by the POS device 450 is payable, using the received payment information. In addition, the server 900 may determine whether the received signature-free payment data is valid.

Meanwhile, if the server 900 does not determine whether signature-free payment is available or the payment signal does not include the signature-free payment data, the server 900 may determine whether signature-free payment is available based on the payment availability verification request in operation 1919. For example, the server 900 may determine whether a shop corresponding to the POS device 450 has subscribed to the signature-free service, based on information about the shop corresponding to the POS device 405 that has requested payment availability verification, which will be described with reference to FIG. 18.

The server 900 may store the database 1820 for signature-free service merchant subscribers, illustrated in FIG. 18. Upon receipt of a payment availability verification request from the POS device 450, the server 900 may determine whether a shop corresponding to the POS device 450 has subscribed to the signature-free service. For example, the server 900 may determine whether the requested shop has subscribed to the signature-free service, based on the DB 1820 for signature-free service merchant subscribers. If the shop corresponding to the POS device 450 has subscribed to the signature-free service, the server 900 may determine that signature-free payment is available. If the shop corresponding to the POS device 450 has not subscribed to the signature-free service, the server 900 may determine that a signature is required for payment. If the server 900 determines that payment is available without receiving a signature, the server 900 may transmit a later-described payment availability verification request response signal including signature-free payment data to the POS device 450.

In operation 1930, the server 900 may transmit a payment availability verification request response signal to the POS device 450. On the other hand, if the server 900 determines that the payment is not available, the server 900 may transmit a negative payment availability verification request response signal to the POS device 450.

In operation 1932, upon receipt of the payment availability verification request response signal, the POS device 450 may perform payment using the payment information and the signature-free payment data. Therefore, the POS device 450 may not receive a user's signature separately.

In operation 1934, the POS device 450 may transmit payment approval information to the server 900 according to the performed payment. The payment approval information may include information about a slip for which payment has been approved.

In operation 1936, the server 900 may store the received payment approval information.

As such, the electronic payment system 40 according to an embodiment of the present disclosure may perform payment without receiving a signature directly from a user. Therefore, an unnecessary signature signing operation can be skipped during electronic payment, and the electronic payment system 40 can shorten a time taken for payment and increase user satisfaction regarding electronic payment. Further, the present disclosure can provide high-level security and safety through various user authentication operations, compared to a signature signing method.

As is apparent from the foregoing description, according to an embodiment of the present disclosure, an electronic payment system may perform payment without receiving a signature directly from a user. Therefore, an unnecessary signature signing operation can be skipped during electronic payment, and the electronic payment system can shorten a time taken for payment and increase user satisfaction regarding electronic payment.

Further, the present disclosure can provide high-level security and safety through various user authentication operations, compared to a signature signing method.

Each of the above-described components of the electronic device may include one or more parts and the name of the component may vary with the type of the electronic device. According to various embodiments, the electronic device may be configured to include at least one of the previously described components. Some component may be omitted from or added to the electronic device. According to various embodiments, one entity may be configured by combining a part of the components of the electronic device, to thereby perform the same functions of the components prior to the combining.

The term “module” as used herein may refer to a unit including one or a combination of two or more of hardware, software, and firmware. The term “module” may be used interchangeably with terms such as, for example, unit, logic, logical block, component or circuit. A “module” may be the smallest unit of an integrated part or a portion thereof. A “module” may be the smallest unit for performing one or more functions, or a portion thereof. A “module” may be implemented mechanically, or electronically. For example, a “module” may include at least one of a known, or to-be-developed, processing circuitry, dedicated processor, CPU, application-specific integrated circuit (ASIC) chip, field-programmable gate array (FPGA) or programmable logic device that perform certain operations.

At least a part of devices (for example, modules or their functions) or methods (for example, operations) according to various embodiments of the present disclosure may be implemented as commands stored in a computer-readable storage medium, in the form of a programming module. When the commands are executed by a processor (for example, the processor 120), one or more processors may execute functions corresponding to the commands. The computer-readable storage medium may be, for example, the memory 130.

The computer-readable medium may include hard disk, floppy disk, magnetic media (for example, magnetic tape), optical media (for example, compact disc read-only memory (CD-ROM)), digital versatile disc (DVD), magneto-optical media (for example, floptical disk), hardware devices (for example, read-only memory (ROM), random access memory (RAM) or flash memory)), and the like. Program instructions may include machine language code that are produced by a compiler or high-level language code that may be executed by a computer using an interpreter. The functionalities of hardware discussed above may be implemented as one or more software modules, and vice versa in order to perform an operation according to various embodiments.

A module or a programming module according to various embodiments of the present disclosure may include one or more of the above-described components, may omit a portion thereof, or may include additional components. Operations that are performed by a module, a programming module or other components according to the present disclosure may be processed in a serial, parallel, repetitive or heuristic manner. Also, some operations may be performed in a different order or omitted, or additional operations may be added.

The various example embodiments disclosed in the present description are provided for description and understanding of the present disclosure, not limiting the scope of the present disclosure. Accordingly, the scope of the present disclosure should be understood as embracing all modifications or various embodiments within the scope of the present disclosure therein.

What is claimed is:

1. A method for operating an electronic device, the method comprising:
executing a payment application for electronic payment;
authenticating a user in the executed payment application; and
transmitting a payment signal including payment information corresponding to a user input and signature image data corresponding to the user input.

2. The method of claim 1, wherein the signature image data includes at least one of: a signature code and signature image corresponding to a signature of the authenticated user.

3. The method of claim 2, further comprising:
transmitting a payment signal including the signature image by near field communication (NFC); and
transmitting a payment signal including the signature code by magnetic secure transmission (MST).

4. The method of claim 1, wherein the transmission of a payment signal comprises:
determining whether the authenticated user corresponds to signature-free payment; and
if the authenticated user corresponds to signature-free payment, including signature-free payment data in the payment signal to allow payment without receiving a signature, and transmitting the payment signal.

5. The method of claim 1, wherein the transmission of a payment signal comprises:
determining whether a shop corresponding to a location of the electronic device corresponds to signature-free payment; and
if the shop corresponding to the location of the electronic device corresponds to signature-free payment, including signature-free payment data in the payment signal to allow payment without receiving a signature, and transmitting the payment signal.

6. The method of claim 4, wherein the determination comprises receiving the signature-free payment data from the outside of the electronic device.

7. A method for operating an electronic device, the method comprising:
receiving a payment signal including payment information corresponding to a user input and signature image data corresponding to a user; and
performing payment using the payment information and the signature image data.

8. The method of claim 7, further comprising:
receiving a payment signal including the signature image by near field communication (NFC); and
receiving a payment signal including the signature code by magnetic secure transmission (MST).

9. The method of claim 7, wherein the performing of payment comprises:
acquiring a signature image included in the signature image data; and
performing payment using the payment information and the obtained signature image.

10. The method of claim 7, wherein the performing of payment comprises:
querying a server about a signature code or signature image included in the signature image data;
receiving a response to the query from the server; and
performing payment using the payment information and the signature image based on the received response.

11. The method of claim 7, wherein the performing of payment comprises:
verifying signature-free payment data included in the payment signal; and
performing payment using the payment information based on the verified signature-free payment data, without receiving a signature from the user.

12. The method of claim 7, wherein the performing of payment comprises:
querying a server about whether the user corresponds to signature-free payment;
receiving a response to the query from the server; and
performing payment using the payment information based on the received response, without receiving a signature from the user.

13. An electronic device comprising:
a memory;
a communication module comprising communication circuitry configured to transmit a payment signal; and
a processor connected electrically to the memory and the communication module,
wherein the memory stores instructions, and the processor is configured to execute the instructions stored in the memory to perform operations comprising: executing a payment application for electronic payment, authenticating a user in the executed payment application, and transmitting a payment signal including payment information corresponding to a user input and signature image data of the user.

14. The electronic device of claim 13, wherein the signature image data includes at least one of: a signature code and signature image corresponding to a signature of the authenticated user.

15. The electronic device of claim 13, wherein the operations further comprise: transmitting a payment signal including the signature image by near field communication (NFC), and transmitting a payment signal including the signature code by magnetic secure transmission (MST).

16. The electronic device of claim 13, wherein the operations further comprise: determining whether the authenticated user corresponds to signature-free payment, and if the authenticated user corresponds to signature-free payment, including signature-free payment data in the payment signal to allow payment without receiving a signature and transmitting the payment signal.

17. The electronic device of claim 13, wherein the operations further comprise: determining whether a shop corresponding to a location of the electronic device corresponds to signature-free payment, and if the shop corresponding to the location of the electronic device corresponds to signature-free payment, including signature-free payment data in the payment signal to allow payment without receiving a signature and transmitting the payment signal.

18. The electronic device of claim 13, wherein the operations further comprise: requesting a token to a server through the communication circuitry of the communication module, and receiving the requested token from the server.
